(19) United States
(12) Patent Application Publication
(10) Pub. No.: US 2020/0010985 A1
(43) Pub. Date: Jan. 9, 2020

(54) Thermoplastic Polyurethane Yarn And Fabric Made Therefrom

(71) Applicant: Heedae PARK, Busan (KR)

(72) Inventor: Heedae PARK, Busan (KR)

(21) Appl. No.: 16/132,642

(22) Filed: Sep. 17, 2018

(30) Foreign Application Priority Data
Jul. 5, 2018 (KR) 10-2018-0077965

(51) Int. Cl. D02G 3/04; C08L 75/04; C08G 18/34; C08K 3/36; D01F 6/70; C08G 18/32

(52) U.S. Cl. CPC D02G 3/045; C08L 75/04; C08G 18/341; C08K 3/36; D01F 6/70; C08K 2201/011; C08L 2203/12; D10B 2331/10; D10B 2101/02; D10B 2401/06; C08G 18/3206

(57) ABSTRACT

Disclosed is a thermoplastic polyurethane yarn and a fabric made from the thermoplastic polyurethane yarn that uses succinate as a polyol in a thermoplastic polyurethane composition comprises of isocyanate, glycol and polyol, and further includes nano-silica having a particle size of 100 nm or less added in the polymerization of the composition, thereby increasing the crystallization rate during the cooling and drawing processes to enable a continuous spinning of yarns without yarn breaking and also realizing a continuous spinning of low-hardness (Shore A type) thermoplastic polyurethane yarns with great stretch and recovery.

### CROSS-REFERENCE TO RELATED APPLICATION

This application claims priority to Korean Patent Application No. 10-2018-0077965, filed on Jul. 5, 2018, and all the benefits accruing therefrom under 35 U.S.C. § 119, the contents of which in its entirety are herein incorporated by reference.

### BACKGROUND

The present invention relates to a thermoplastic polyurethane yarn including polyol, isocyanate, and glycol, and more particularly to a thermoplastic polyurethane yarn and a fabric made from the thermoplastic polyurethane yarn that uses succinate as a polyol and further includes nano-silica having a particle size of 100 nm or less added in the polymerization of the composition, thereby increasing the crystallization rate during the cooling and drawing processes to enable a continuous spinning of yarns without yarn breaking and also realizing a continuous spinning of low-hardness (Shore A type) thermoplastic polyurethane yarns with great stretch and recovery.

Generally, yarns for weaving include polyester, nylon, acrylic resin, or the like. The fabrics made from the weaving yarns are poor in durability and wear resistance and problematic in many aspects such as adhesiveness, so they are not suitable for high functionality applications such as fabrics for the upper section of shoes.

In recent years, many studies have been made to enhance the strength of the yarns as a solution to this problem. An example of such yarns currently available is a yarn (hereinafter, referred to as “coated yarn”) prepared by applying a coating of a thermoplastic resin (e.g., PVC, PP, etc.) on the surface of a yarn made of polyester, nylon, and so forth.

The use of a regular thermoplastic resin as above, however, leads to the difficulty in adjusting the amount of the thermoplastic resin applied on the yarn, particularly facing the challenge in applying the thermoplastic resin in a small amount, unavoidably creating a coated yarn as thick as 350 denier or above, which adversely leads to poor properties in terms of durability and wear resistance.

In an attempt to solve this problem, the inventors of the present invention have made sustained studies on the coated yarns prepared by applying a coating of thermoplastic polyurethane on the surface of a yarn, as disclosed in the following patent documents 1 to 4, since 2012.

The prior inventions disclosed in the patent documents 1 to 4 can provide coated thermoplastic polyurethane (TPU) yarns excellent in wear resistance, adhesion, water resistance, moldability, etc., but necessarily require the use of a core yarn such as of polyester, nylon, etc., making it impossible to produce coated yarns having a low thickness. Furthermore, the coated thermoplastic polyurethane (TPU) yarns do not have such a high viscosity as polyester or nylon yarns due to the characteristics of thermoplastic polyurethane, so a continuous spinning of yarns is impossible to realize without yarn breaking during the cooling and drawing processes.

Unlike the coated thermoplastic polyurethane (TPU) yarns of the prior art, a thick monofilament yarn can be easily produced by melt extrusion in the presence of silica having a regular size as a thickening agent. But, a multifilament yarn below 50 denier (that is, the fiber thickness of a single filament with a denier count of less than 50) or a monofilament yarn of 50 to 350 denier, in the presence of a regular silica as a thickening agent, is subject to breakage during the cooling and drawing processes, which results in a failure of continuous spinning of the yarn and hence the reduction of productivity.

In order to solve this problem, specifically with the prior art concerning the difficulty in continuously spinning yarns of a low thickness without yarn breakage, the inventors of the present invention have contrived the thermoplastic polyurethane yarns as disclosed in the following patent documents 5 to 9.

In the prior art according to the patent documents 5 to 9, the production of thermoplastic polyurethane yarns, more specifically, monofilament or multifilament yarns involves polymerizing a regular thermoplastic polyurethane composition in combination with nano-silica and then performing melt extrusion to spin thermoplastic polyurethane yarns continuously without yarn breakage during the cooling and drawing processes and also to accomplish a continuous spinning of thin thermoplastic polyurethane yarns, namely, monofilament yarns having a denier count of 50 to 350 and multifilament yarns having a denier count of 50 or less without yarn breakage.

Although the prior inventions are useful in the aspect that thin thermoplastic polyurethane yarns can be continuously spun without yarn breakage, the production of low-hardness (Shore A type) thermoplastic polyurethane yarns faces the challenge in having occasional yarn breakage during the cooling and drawing processes. Particularly, when creating yarns from a low-hardness (e.g., 98A, 90A, 70A) thermoplastic polyurethane resin, the crystallization rate is so low that the yarns are easily broken rather than continuously spun during the cooling and drawing processes. Furthermore, the fabrics made from the thermoplastic polyurethane yarns do not recover as woven fabrics do; namely, they do not have great stretch and recovery.

Particularly, there have recently been growing demands for yarns and fabrics that not only maintain strong properties characteristic to thermoplastic polyurethane but also have great stretch and recovery. In the general production of thermoplastic polyurethane that uses adipate based on adipic acid as a polyol, the crystallization rate of low-hardness (Shore A type) thermoplastic polyurethane is so low that it is very difficult to realize a continuous production of thermoplastic polyurethane yarns.

### RELATED ART DOCUMENT

### Patent Document

(Patent Document 1) Korean Patent No. 10-1341054

(Patent Document 2) Korean Patent No. 10-1530149 (Patent Document 3) Korean Patent No. 10-1318135

(Patent Document 4) Korean Patent No. 10-1341055

(Patent Document 5) Korean Patent Laid-Open Publication No. 10-2018-0039546

(Patent Document 6) U.S. Pat. No. 9,914,819 B2

(Patent Document 7) U.S. Pat. No. 9,915,027 B2

(Patent Document 8) U.S. Pat. No. 9,915,026 B2

(Patent Document 9) U.S. Pat. No. 9,914,808 B2

### SUMMARY

It is an object of the present invention to provide a thermoplastic polyurethane yarn that can be spun continuously without yarn breakage by accelerating the crystallization rate during the cooling and drawing processes in the production of a thermoplastic polyurethane yarn from a low-hardness (Shore A type) thermoplastic polyurethane resin.

It is another object of the present invention to provide a thermoplastic polyurethane yarn capable of realizing great stretch and recovery and a fabric made from the thermoplastic polyurethane yarn.

It is still another object of the present invention to provide a thermoplastic polyurethane yarn that can be spun continuously without yarn breakage by accelerating the crystallization rate during the cooling and drawing processes in the production of multifilament yarns having a denier count of 50 or less.

It is still further another object of the present invention to provide a thermoplastic polyurethane yarn having an elongation increased depending on the content of succinate, and a fabric made from the yarn.

In accordance with the present invention, there is provided a thermoplastic polyurethane yarn that includes a thermoplastic polyurethane composition using succinate as a polyol, and nano-silica.

The thermoplastic polyurethane yarn of the present invention may be made from a low-hardness (Shore A type) thermoplastic polyurethane yarn, and the yarn has great stretch and recovery.

The thermoplastic polyurethane yarn of the present invention may include a thermoplastic polyurethane composition, which is composed of isocyanate, glycol and polyol, and nano-silica. The polyol is succinate.

The thermoplastic polyurethane yarn may further include adipate polyol.

The nano-silica has a particle size of 100 nm or less, and the thermoplastic polyurethane composition includes 10 to 50% of the succinate polyol.

A single filament of fiber is 50 denier or below when the thermoplastic polyurethane yarn is a multifilament yarn; while a single filament of fiber is 50 to 350 denier when the thermoplastic polyurethane yarn is a monofilament yarn.

The nano-silica and the succinate are used not only to enable the thermoplastic polyurethane yarn to be spun continuously without yarn breakage during the cooling and spinning processes but also to impart great stretch and recovery to the yarn.

In accordance with the present invention, there is also provided a fabric made from the thermoplastic polyurethane yarn, and the fabric has great stretch and recovery.

In the present invention, the content of succinate is 5 to 30% when the thermoplastic polyurethane has a hardness of 75D.

In the present invention, the content of succinate is 5 to 40% when the thermoplastic polyurethane has a hardness of 60D.

In the present invention, the content of succinate is 5 to 45% when the thermoplastic polyurethane has a hardness of 98A.

In the present invention, the content of succinate is 10 to 55% when the thermoplastic polyurethane has a hardness of 90A.

In the present invention, the content of succinate is 20 to 75% when the thermoplastic polyurethane has a hardness of 70A.

The present invention involves using succinate as a polyol component of the thermoplastic polyurethane composition including isocyanate, glycol, and polyol, and adding nano-silica to the composition during the polymerization to accelerate the crystallization rate during the cooling and drawing processes in the production of a thermoplastic polyurethane yarn, thereby not only enabling a continuous spinning of the thermoplastic polyurethane yarn without yarn breakage but also producing the thermoplastic polyurethane yarn with great stretch and recovery.

In the production of the thermoplastic polyurethane yarn of the present invention, it is possible to prepare the thermoplastic polyurethane yarn with stretch and recovery directionally changed by adjusting the contents of succinate and nano-silica and also to produce a fabric from the thermoplastic polyurethane yarn in various shapes.

The present invention not only enables a continuous spinning of yarns without yarn breakage during the cooling and drawing processes in the production of yarns from a low-hardness (Shore A type) thermoplastic polyurethane resin with great stretch and recovery, but also produces a multifilament yarn with a denier count of 50 or less continuously spun irrespective of the hardness of the thermoplastic polyurethane resin.

The present invention can increase the elongation of the yarn by raising the content of succinate in the production of the thermoplastic polyurethane yarn, thereby enhancing the stretch and recovery of the existing thermoplastic polyurethane resin.

### BRIEF DESCRIPTION OF THE DRAWINGS

FIG. 1 is a graph showing recrystallization when the thermoplastic polyurethane having a hardness of 90A according to the present invention is consistently cooled down.

FIG. 2 is a graph showing the rate of crystallization as a function of time when the thermoplastic polyurethane having a hardness of 90A according to the present invention is abruptly cooled down to a specific temperature and maintained at the temperature.

FIG. 3 is a graph showing recrystallization when the thermoplastic polyurethane having a hardness of 75D according to the present invention is consistently cooled down.

FIG. 4 is a graph showing the rate of crystallization as a function of time when the thermoplastic polyurethane having a hardness of 75D according to the present invention is abruptly cooled down to a specific temperature and maintained at the temperature.

### DETAILED DESCRIPTION OF THE EMBODIMENTS

Hereinafter, the preferred embodiments of the present invention will be described in detail as follows. A representative embodiment of the present invention will be given in the following detailed description for the sake of accomplishing the above-specified technical objects of the present invention. The other embodiments available in the present invention are replaced by the description of the present invention.

The term “nano-silica” as used herein refers to silica having a particle size of 100 nm or less, and the term “thermoplastic polyurethane yarn” or “TPU yarn” as used herein means a monofilament or multifilament yarn made from a thermoplastic polyurethane resin. When the thermoplastic polyurethane yarn is referred to as being “continuously produced”, it can be continuously spun without yarn breakage during the cooling and drawing processes. The term “spinning” as used herein refers to any spinning process for synthetic fiber, such as dry spinning, wet spinning, electrospinning, etc., in addition to the melt spinning process based on melt extrusion as described in this specification. Although it is stated in this specification that a continuous spinning is carried out through the melt extrusion process in the production of a thermoplastic polyurethane yarn, the thermoplastic polyurethane yarn of the present invention can also be produced by dry spinning, wet spinning, electrospinning, etc. in addition to melt spinning.

The term “low hardness” as used herein refers to a hardness value (ranging from 0 to 100) determined by measuring with a Shore A durometer; and the term “high hardness” as used herein refers to a hardness value (ranging from 0 to 100) determined by measuring with a Shore D durometer. Accordingly, the term “low-hardness (Shore A type)” as used herein means having a hardness value determined by a Shore A durometer; and the term “low-hardness (Shore D type)” as used herein means having a hardness value determined by a Shore D durometer.

According to the present invention, in the production of thermoplastic polyurethane yarns (specifically, TPU monofilament or multifilament yarns) from a thermoplastic polyurethane composition including polyol, isocyanate, and glycol, the succinate prepared by mixing succinic acid as one of raw materials for thermoplastic polyurethane with adipic acid at a predetermined ratio is used to accelerate the crystallization rate of low-hardness (Shore A type; e.g., 98A, 90A, 70A) thermoplastic polyurethane resins in the melt extrusion process, thereby realizing a thermoplastic polyurethane yarn and a fabric made from the thermoplastic polyurethane yarn that enable a continuous spinning of yarns through melt spinning without yarn breakage during the cooling and drawing processes The production of yarns using low-hardness (Shore A type) thermoplastic polyurethane resins, which inherently have high tensile strength and high elongation, can realize thermoplastic polyurethane yarns with great stretch and recovery. But, the low-hardness (Shore A type) thermoplastic polyurethane resin has such a low crystallization rate that yarn breakage frequently takes place during the spinning process, more specifically, in the melt spinning process. For solving this problem, the present invention involves using succinate as a polyol and adding nano-silica to the thermoplastic polyurethane composition during the polymerization process to accelerate the crystallization rate in the melt spinning process, thereby realizing a continuous spinning of yarns without yarn breakage. The thermoplastic polyurethane yarn of the present invention thus obtained has a low hardness (Shore A) and hence great stretch and recovery. In this regard, it is natural that the fabric made from the thermoplastic polyurethane yarn of the present invention also has great stretch and recovery. Particularly, even if the thermoplastic polyurethane resin has a low hardness of 70A, it is possible not only to enable a continuous spinning of yarns without yarn breakage during the melt extrusion process but also to maintain great stretch and recovery.

As described above, the present invention uses succinate as a polyol component of a general thermoplastic polyurethane composition (polyol, isocyanate, glycol) and adds nano-silica having a particle size of 100 nm or less to the composition during the polymerization to accelerate the crystallization rate in the melt extrusion process of the thermoplastic polyurethane resin, thereby enabling a continuous spinning of yarns without yarn breakage during the cooling and drawing processes and producing a thermoplastic polyurethane yarn with great stretch and recovery. Naturally, the fabric made from the thermoplastic polyurethane yarn also has great stretch and recovery.

In this manner, for stably producing a thermoplastic polyurethane yarn, more specifically, realizing a continuous spinning of the thermoplastic polyurethane yarn without yarn breakage during the melt spinning process, it is very important to adjust the crystallinity of the thermoplastic polyurethane resin and also necessary to use nano-silica having a particle size of 100 nm or less as a processing aid. The thermoplastic polyurethane is a resin with a variable dynamic viscosity that depends on temperature. Therefore, the nano-silica as used in the present invention reduces the temperature-dependent change of viscosity (dynamic viscosity) of the thermoplastic polyurethane resin in the production of thermoplastic polyurethane yarns to realize the stable melt extrusion of the thermoplastic polyurethane resin and thereby to produce a yarn with a uniform thickness.

For thick (about 350 denier or above) monofilament yarns, it is possible to produce yarns stably using silica of a regular size. On the other hand, for thin (50 to 350 denier) monofilament yarns, the use of regular-sized silica causes yarn breakage during the cooling and drawing processes. To solve this problem, nano-silica having a particle size of 100 nm or less is used to continuously produce a thermoplastic polyurethane yarn.

For production of a multifilament yarn, which involves spinning a single filament of fiber to a low thickness of 50 denier or less, a high-hardness (Shore D: 75D for example) thermoplastic polyurethane (TPU) has a high crystallization rate, but with a take-up velocity of 1,000 rpm at maximum, so it is impossible to increase the take-up velocity by using nano-silica alone, and yarn breakage occurs unavoidably during the cooling and drawing processes. Therefore, the present invention involves using succinate in combination with nano-silica for the purpose of increasing the take-up velocity in the production of multifilament yarns, to accelerate the crystallization rate during the cooling and drawing processes and to realize a continuous spinning without yarn breakage. Naturally, great stretch and recovery can be secured when producing multifilament yarns from low-hardness (Shore A type) thermoplastic polyurethane resins.

In the production of thermoplastic polyurethane yarns according to the present invention, a polyol is prepared by mixing succinic acid and adipic acid at a defined mixing ratio depending on the use purpose (i.e., elongation of yarns or fabric) and then polymerized with a thermoplastic polyurethane composition to prepare a thermoplastic polyurethane resin. In this regard, the thermoplastic polyurethane resin can be prepared in the presence of nano-silica added as a processing aid during the polymerization process or using a separate master batch. The use of the resultant thermoplastic polyurethane resin in making monofilament or multifilament yarns secures a continuous spinning of yarns without yarn breakage during the melt extrusion process and results in producing a variety of thermoplastic polyurethane yarns, particularly ranging from low-hardness (Shore A type) thermoplastic polyurethane yarns with great stretch and recovery to high-hardness (Shore D type) thermoplastic polyurethane yarns, and fabrics using the thermoplastic polyurethane yarns.

As described above, the thermoplastic polyurethane yarn of the present invention contains a general thermoplastic polyurethane composition composed of polyol, isocyanate, and glycol. Particularly, the polyol as used herein is succinate (e.g., 1,4-bd succinate using succinic acid), and nano-silica having a particle size of 100 nm or less is added to the thermoplastic polyurethane composition during the polymerization. In this regard, the polyol may include adipate (e.g., 1,4-bd adipate using adipic acid) according to the present invention. The polyol as used herein may further include glutaric acid, heptanedioic acid, suberic acid, azelaic acid, sebacic acid, dodecanedioic acid, isophthalic acid, terephthalic acid, cyclohexanoic acid, or dicarboxylic acid.

The general thermoplastic polyurethane composition includes isocyanate and glycol. The isocyanate includes aromatic isocyanate and aliphatic isocyanate, specifically including MDI, XDI, H12MDI, HDI, TDI, IPDI, LDI, BDI, PDI, CHDI, TODI, NDI, etc., which are used alone or in combination. The term “glycol” as used herein means a short-chain glycol, specifically including ethylene glycol, diethylene glycol, propylene glycol, dipropylene glycol, butanediol, hexanediol, pentanediol, neopentyl glycol, cyclohexane dimethanol, hexamethylenediol, heptanediol, nonanediol, dodecanediol, etc., which are used alone or in combination.

In the following description of this disclosure, there is provided a preferred embodiment of the present invention that involves using succinate as a polyol component of a general thermoplastic polyurethane composition (isocyanate and glycol) in the production of a thermoplastic polyurethane yarn and adding nano-silica having a particle size of 100 nm or less during the polymerization of the composition to accelerate the crystallization rate in the melt extrusion process, thereby enabling a continuous spinning of yarns without yarn breakage during the cooling and drawing processes in the production of yarns from low-hardness (Shore A type) thermoplastic polyurethane resins with great stretch and recovery. There is also specifically provided another preferred embodiment of the present invention that realizes a continuous spinning of yarns not only in the production of multifilament yarns using a high-hardness (Shore D type) thermoplastic polyurethane resin without yarn breakage but also in the production of low-hardness (Shore A type) multifilament yarns having great stretch and recovery without yarn breakage during the cooling and drawing processes.

### Example 1

An example is given to describe that succinate and nano-silica are used in the production of a thermoplastic polyurethane yarn to accelerate the crystallization rate during the cooling and drawing processes.

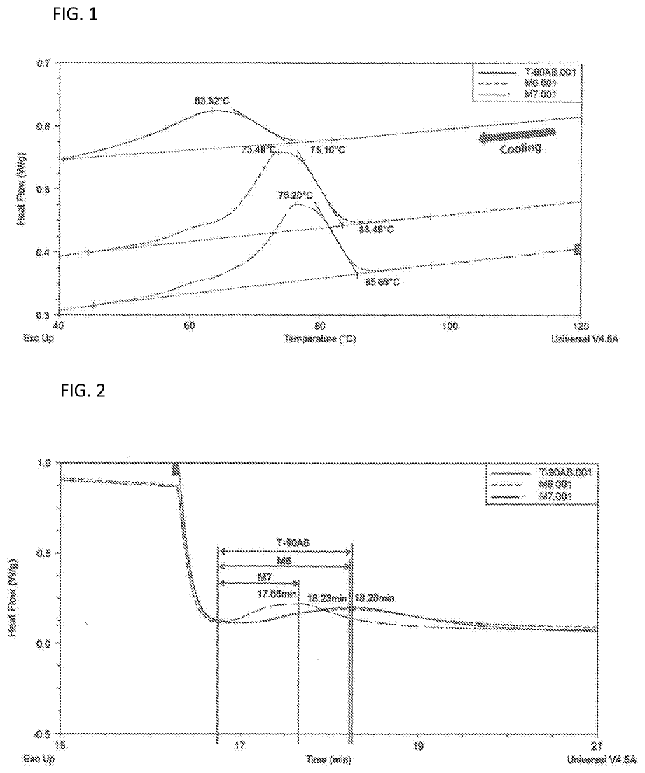

FIGS. 1 to 4 are graphs showing the crystallization rate analyzed by the differential scanning calorimetry (DSC). The conditions of the DSC analysis on the crystallization rate are given as follows:

1. Heating from 25° C. to 250° C., Rate 10° C./min.

2. Equilibrium for 2 minutes.

3. Cooling to crystallization temperature, Rate 10° C./min.

4. Isotherm for 15 minutes.

* Crystallization temperature

T-90AB, M6, M7: 90° C.

T-75D, M3: 150° C.

In this regard, T-90AB is a thermoplastic polyurethane resin having a succinate content of 0% and an adipate content of 61% with a hardness of 90A; M6 is a thermoplastic polyurethane resin having a succinate content of 30% and an adipate content of 31% with a hardness of 90A; M7 is a thermoplastic polyurethane resin having a succinate content of 40% and an adipate content of 21% with a hardness of 90A; T-75D is a thermoplastic polyurethane resin having a succinate content of 0% and an adipate content of 35% with a hardness of 75D; and M3 is a thermoplastic polyurethane resin having a succinate content of 20% and an adipate content of 15% with a hardness of 75D.

Generally, crystals dissociated (melted) by heating get to recrystallization by cooling; FIG. 1 shows the cooling process. Referring to the graph of FIG. 1, with the progress of cooling, M6 and M7 get to exothermic (the upper peak) recrystallization at higher temperature than T-90AB, and M7 starts to recrystallize at a little higher temperature than M6. The polymer more prone to crystallization is recrystallized at higher temperature; therefore, the thermoplastic polyurethane resins can be arranged as M7>M6>T-90AB in order of decreasing likelihood of recrystallization.

FIG. 2 is a graph showing the rate of crystallization as a function of time when the thermoplastic polyurethane having a hardness of 90A is abruptly cooled down to a specific temperature (90° C.) and maintained at the temperature. As shown in the graph of FIG. 2, M7 gets to the exothermic process (recrystallization) in the shortest period of time; and M6 takes time almost the same as or shorter than T-90AB to get to the exothermic process. Namely, the thermoplastic polyurethane resins can be arranged as M7>M6>T-90AB in order of decreasing crystallization rate.

More specifically, the crystallization time of thermoplastic polyurethane resins with a hardness of 90A is 18.26 min for T-90AB having a succinate content of 0%, 18.23 min for M6 having a succinate content of 30%, and 17.66 min for M7 having a succinate content of 40%. It can be seen from the data that the crystallization rate increases with an increase in the succinate content.

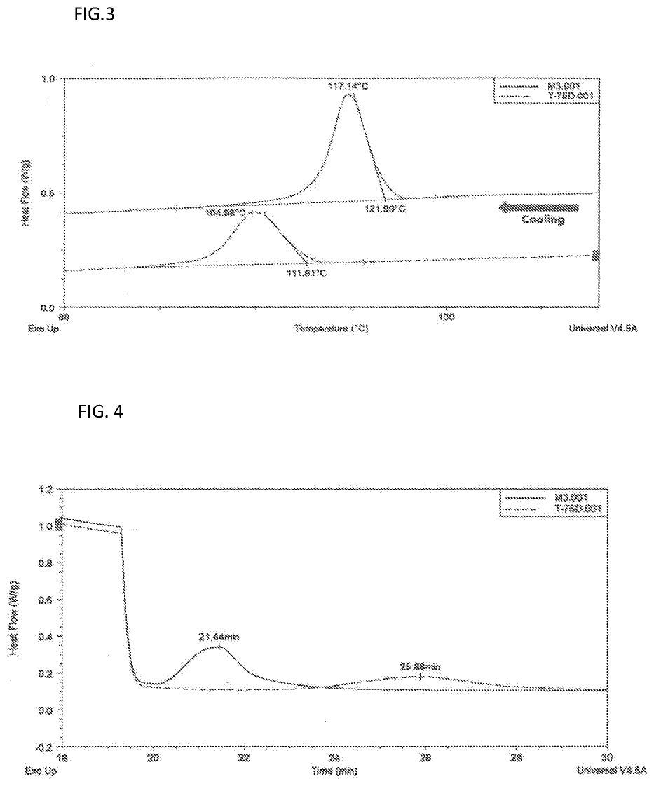

Referring to FIGS. 3 and 4, M3 gets to recrystallization at higher temperature and is far more prone to crystallization than T-75D. An isothermal crystallization testing shows that M3 gets to crystallization much faster than T-75D; that is, M3 has the higher crystallization rate. More specifically, the crystallization time of thermoplastic polyurethane resins with a hardness of 75D is 25.88 min for T75D having a succinate content of 0%, and 21.44 min for M3 having a succinate content of 20%. In conclusion, the crystallization rate increases with an increase in the succinate content.

### Example 2

Tables 1 to 6 present the mixing ratios of the individual compositions for production of the thermoplastic polyurethane yarns of the present invention from thermoplastic polyurethane (TPU) having a hardness of 75D. In other words, the following tables specifically show the elongation and processability of the thermoplastic polyurethane yarns with succinate and nano-silica contents under control. The elongation measurement of the thermoplastic polyurethane yarn was all the same for multifilament and monofilament yarns. The term “elongation” as used herein refers to the ability of stretch and recovery of the thermoplastic polyurethane yarn; and the term “processability” means the spinnability of yarns in the cooling and drawing processes during melt extrusion in the production of thermoplastic polyurethane yarns.

The general thermoplastic polyurethane composition, specifically the isocyanate and glycol contents, as presented in each of the following tables do not affect the objects and effects of the present invention, so the isocyanate and glycol contents should not be construed as limiting the scope of the invention. This is applied equally to all the following tables.

TABLE 1

| | TPU composition (100%) | | |
|---|---|---|---|
| | Succinate content (0.0%), Adipate content (35.0%), | | |
| | Glycol content (15.0%), Isocyanate content (50.0%) | | |
| | | Processability | |
| Nano-silica | | Multifilament yarn | |
| content | Elongation | (5 denier, 36 | Monofilament yarn |
| (phr) | (%) | filler) | (150 to 200 denier) |
| 0.0 | 54 | Yarn breakage | Good processability |
| | | (Not working) | during extrusion, |
| | | | Yarn breakage 30% |
| 0.5 | 58 | Good | Good processability |
| | | processability | during extrusion, |
| | | during extrusion, | Yarn breakage 20% |
| | | Yarn breakage 15% | |
| 1.0 | 60 | Good | Good processability |
| | | processability | during extrusion, |
| | | during extrusion, | Yarn breakage 10% |
| | | Yarn breakage 20% | |
| 2.0 | 62 | Good | Too slippery |
| | | processability | surface and extreme |
| | | during extrusion, | crystallization |
| | | Yarn breakage 25% | |
| 3.0 | 65 | Too slippery | Too slippery |
| | | surface and | surface and extreme |
| | | extreme | crystallization |
| | | crystallization | |
| 5.0 | 64 | Too slippery | Too slippery |
| | | surface and | surface and extreme |
| | | extreme | crystallization |
| | | crystallization | |

TABLE 2

| | TPU composition (100%) | | |
|---|---|---|---|
| | Succinate content (5.0%), Adipate content (30.0%), | | |
| | Glycol content (15.0%), Isocyanate content (50.0%) | | |
| | | Processability | |
| Nano-silica | | Multifilament yarn | |
| content | Elongation | (5 denier, 36 | Monofilament yarn |
| (phr) | (%) | filler) | (150 to 200 denier) |
| 0.0 | 52 | Yarn breakage | Good processability |
| | | (Not working) | during extrusion, |
| | | | Yarn breakage 20% |
| 0.5 | 54 | Good | Good processability |
| | | processability | during extrusion, |
| | | during extrusion, | Good surface |
| | | Good surface | without yarn |
| | | without yarn | breakage |
| | | breakage | |
| 1.0 | 59 | Good | Good processability |
| | | processability | during extrusion, |
| | | during extrusion, | Good surface |
| | | Good surface | without yarn |
| | | without yarn | breakage |
| | | breakage | |
| 2.0 | 61 | Good | Good processability |
| | | processability | during extrusion, |
| | | during extrusion, | Good surface |
| | | Good surface | without yarn |
| | | without yarn | breakage |
| | | breakage | |
| 3.0 | 59 | Good | Good processability |
| | | processability | during extrusion, |
| | | during extrusion, | Good surface |
| | | Good surface | without yarn |
| | | without yarn | breakage |
| | | breakage | |
| 5.0 | 55 | Too slippery | Too slippery |
| | | surface and | surface and extreme |
| | | extreme | crystallization |
| | | crystallization | |

TABLE 3

| | TPU composition (100%) | | |
|---|---|---|---|
| | Succinate content (10.0%), Adipate content (25.0%), | | |
| | Glycol content (15.0%), Isocyanate content (50.0%) | | |
| | | Processability | |
| Nano-silica | | Multifilament yarn | |
| content | Elongation | (5 denier, 36 | Monofilament yarn |
| (phr) | (%) | filler) | (150 to 200 denier) |
| 0.0 | 57 | Yarn breakage | Good processability |
| | | (Not working) | during extrusion, |
| | | | Yarn breakage 20% |
| 0.5 | 60 | Good | Good processability |
| | | processability | during extrusion, |
| | | during extrusion, | Good surface |
| | | Good surface | without yarn |
| | | without yarn | breakage |
| | | breakage | |
| 1.0 | 65 | Good | Good processability |
| | | processability | during extrusion, |
| | | during extrusion, | Good surface |
| | | Good surface | without yarn |
| | | without yarn | breakage |
| | | breakage | |
| 2.0 | 64 | Good | Good processability |
| | | processability | during extrusion, |
| | | during extrusion, | Good surface |
| | | Good surface | without yarn |
| | | without yarn | breakage |
| | | breakage | |
| 3.0 | 68 | Good | Good processability |
| | | processability | during extrusion, |
| | | during extrusion, | Good surface |
| | | Good surface | without yarn |
| | | without yarn | breakage |
| | | breakage | |
| 5.0 | 62 | Too slippery | Too slippery |
| | | surface and | surface and extreme |
| | | extreme | crystallization |
| | | crystallization | |

TABLE 4

| | TPU composition (100%) | | |
|---|---|---|---|
| | Succinate content (20.0%), Adipate content (15.0%), | | |
| | Glycol content (15.0%), Isocyanate content (50.0%) | | |
| | | Processability | |
| Nano-silica | | Multifilament yarn | |
| content | Elongation | (5 denier, 36 | Monofilament yarn |
| (phr) | (%) | filler) | (150 to 200 denier) |
| 0.0 | 59 | Yarn breakage | Good processability |
| | | (Not working) | during extrusion, |
| | | | Yarn breakage 15% |
| 0.5 | 62 | Good | Good processability |
| | | processability | during extrusion, |
| | | during extrusion, | Good surface |
| | | Good surface | without yarn |
| | | without yarn | breakage |
| | | breakage | |
| 1.0 | 66 | Good | Good processability |
| | | processability | during extrusion, |
| | | during extrusion, | Good surface |
| | | Good surface | without yarn |
| | | without yarn | breakage |
| | | breakage | |
| 2.0 | 70 | Good | Good processability |
| | | processability | during extrusion, |
| | | during extrusion, | Good surface |
| | | Good surface | without yarn |
| | | without yarn | breakage |
| | | breakage | |
| 3.0 | 68 | Good | Good processability |
| | | processability | during extrusion, |
| | | during extrusion, | Good surface |
| | | Good surface | without yarn |
| | | without yarn | breakage |
| | | breakage | |
| 5.0 | 63 | Too slippery | Too slippery |
| | | surface and | surface and extreme |
| | | extreme | crystallization |
| | | crystallization | |

TABLE 5

| | TPU composition (100%) | | |
|---|---|---|---|
| | Succinate content (30.0%), Adipate content (5.0%), | | |
| | Glycol content (15.0%), Isocyanate content (50.0%) | | |
| | | Processability | |
| Nano-silica | | Multifilament yarn | |
| content | Elongation | (5 denier, 36 | Monofilament yarn |
| (phr) | (%) | filler) | (150 to 200 denier) |
| 0.0 | 64 | Yarn breakage | Good processability |
| | | (Not working) | during extrusion, |
| | | | Yarn breakage 15% |
| 0.5 | 67 | Good | Good processability |
| | | processability | during extrusion, |
| | | during extrusion, | Good surface |
| | | Good surface | without yarn |
| | | without yarn | breakage |
| | | breakage | |
| 1.0 | 71 | Good | Good processability |
| | | processability | during extrusion, |
| | | during extrusion, | Good surface |
| | | Good surface | without yarn |
| | | without yarn | breakage |
| | | breakage | |
| 2.0 | 70 | Good | Good processability |
| | | processability | during extrusion, |
| | | during extrusion, | Good surface |
| | | Good surface | without yarn |
| | | without yarn | breakage |
| | | breakage | |
| 3.0 | 72 | Good | Good processability |
| | | processability | during extrusion, |
| | | during extrusion, | Good surface |
| | | Good surface | without yarn |
| | | without yarn | breakage |
| | | breakage | |
| 5.0 | 70 | Too slippery | Too slippery |
| | | surface and | surface and extreme |
| | | extreme | crystallization |
| | | crystallization | |

TABLE 6

| | TPU composition (100%) | | |
|---|---|---|---|
| | Succinate content (35.0%), Adipate content (0.0%), | | |
| | Glycol content (15.0%), Isocyanate content (50.0%) | | |
| Nano-silica | | Processability | |
| content | Elongation | Multifilament yarn | Monofilament yarn |
| (phr) | (%) | (5 denier, 36 filler) | (150 to 200 denier) |
| 0.0 | 56 | Yarn breakage | Good processability |
| | | (Not working) | during extrusion, |
| | | | Yarn breakage 10% |
| 0.5 | 59 | Yarn breakage | Good processability |
| | | (Not working) | during extrusion, |
| | | | Yarn breakage 10% |
| 1.0 | 58 | Yarn breakage | Too slippery |
| | | (Not working) | surface and extreme |
| | | | crystallization |
| 2.0 | 56 | Too slippery | Too slippery |
| | | surface and extreme | surface and extreme |
| | | crystallization | crystallization |
| 3.0 | 52 | Too slippery | Too slippery |
| | | surface and extreme | surface and extreme |
| | | crystallization | crystallization |
| 5.0 | 49 | Too slippery | Too slippery |
| | | surface and extreme | surface and extreme |
| | | crystallization | crystallization |

As can be seen from Tables 1 to 6, the production of multifilament and monofilament yarns from a thermoplastic polyurethane having a hardness of 75D is impossible to accomplish merely with a succinate content of less than 5% due to low crystallization rate, but successfully realized with a succinate content of 5 to 30% that accelerates the crystallization rate. The succinate content of greater than 30% increases the crystallization rate extremely high, causing yarn breakage too frequently to produce monofilament or multifilament yarns. Meanwhile, the elongation is increased (by about 5 to 25%) with an increase in the succinate content of the thermoplastic polyurethane.

In the present invention, nano-silica is used in combination with succinate in order to prevent yarn breakage during the cooling and drawing processes. For thermoplastic polyurethane having a hardness of 75D, the nano-silica content of 0.5 to 3.0 phr realizes a continuous spinning of yarns without yarn breakage; and the nano-silica content of 5.0 phr results in too slippery surface and extreme crystallization, causing occasional yarn breakage, but no problem in continuously spinning the yarns.

### Example 3

Tables 7 to 13 present the mixing ratios of the individual compositions for production of the thermoplastic polyurethane yarns of the present invention from thermoplastic polyurethane (TPU) having a hardness of 60D. In other words, the following tables specifically show the elongation and processability of the thermoplastic polyurethane yarns with succinate and nano-silica contents under control.

TABLE 7

| | TPU composition (100%) | | |
|---|---|---|---|
| | Succinate content (0.0%), Adipate content (43.0%), | | |
| | Glycol content (13.0%), Isocyanate content (44.0%) | | |
| Nano-silica | | Processability | |
| content | Elongation | Multifilament yarn | Monofilament yarn |
| (phr) | (%) | (5 denier, 36 filler) | (150 to 200 denier) |
| 0.0 | 63 | Yarn breakage | Good processability |
| | | (Not working) | during extrusion, |
| | | | Yarn breakage 20% |
| 0.5 | 64 | Good processability | Good processability |
| | | during extrusion, | during extrusion, |
| | | Yarn breakage 25% | Yarn breakage 15% |
| 1.0 | 68 | Good processability | Good processability |
| | | during extrusion, | during extrusion, |
| | | Yarn breakage 25% | Good surface |
| | | | without yarn |
| | | | breakage |
| 2.0 | 69 | Good processability | Good processability |
| | | during extrusion, | during extrusion, |
| | | Yarn breakage 25% | Good surface |
| | | | without yarn |
| | | | breakage |
| 3.0 | 67 | Good processability | Good processability |
| | | during extrusion, | during extrusion, |
| | | Yarn breakage 25% | Good surface |
| | | | without yarn |
| | | | breakage |
| 5.0 | 61 | Too slippery | Too slippery |
| | | surface and extreme | surface and extreme |
| | | crystallization | crystallization |

TABLE 8

| | TPU composition (100%) | | |
|---|---|---|---|
| | Succinate content (5.0%), Adipate content (38.0%), | | |
| | Glycol content (13.0%), Isocyanate content (44.0%) | | |
| Nano-silica | | Processability | |
| content | Elongation | Multifilament yarn | Monofilament yarn |
| (phr) | (%) | (5 denier, 36 filler) | (150 to 200 denier) |
| 0.0 | 68 | Yarn breakage | Good processability |
| | | (Not working) | during extrusion, |
| | | | Yarn breakage 15% |
| 0.5 | 67 | Good processability | Good processability |
| | | during extrusion, | during extrusion, |
| | | Good surface | Good surface |
| | | without yarn | without yarn |
| | | breakage | breakage |
| 1.0 | 72 | Good processability | Good processability |
| | | during extrusion, | during extrusion, |
| | | Good surface | Good surface |
| | | without yarn | without yarn |
| | | breakage | breakage |
| 2.0 | 76 | Good processability | Good processability |
| | | during extrusion, | during extrusion, |
| | | Good surface | Good surface |
| | | without yarn | without yarn |
| | | breakage | breakage |
| 3.0 | 72 | Good processability | Good processability |
| | | during extrusion, | during extrusion, |
| | | Good surface | Good surface |
| | | without yarn | without yarn |
| | | breakage | breakage |
| 5.0 | 65 | Too slippery | Too slippery |
| | | surface and extreme | surface and extreme |
| | | crystallization | crystallization |

TABLE 9

| | TPU composition (100%) | | |
|---|---|---|---|
| | Succinate content (10.0%), Adipate content (33.0%), | | |
| | Glycol content (13.0%), Isocyanate content (44.0%) | | |
| Nano-silica | | Processability | |
| content | Elongation | Multifilament yarn | Monofilament yarn |
| (phr) | (%) | (5 denier, 36 filler) | (150 to 200 denier) |
| 0.0 | 69 | Yarn breakage | Good processability |
| | | (Not working) | during extrusion, |
| | | | Yarn breakage 15% |
| 0.5 | 73 | Good processability | Good processability |
| | | during extrusion, | during extrusion, |
| | | Good surface | Good surface |
| | | without yarn | without yarn |
| | | breakage | breakage |
| 1.0 | 75 | Good processability | Good processability |
| | | during extrusion, | during extrusion, |
| | | Good surface | Good surface |
| | | without yarn | without yarn |
| | | breakage | breakage |
| 2.0 | 76 | Good processability | Good processability |
| | | during extrusion, | during extrusion, |
| | | Good surface | Good surface |
| | | without yarn | without yarn |
| | | breakage | breakage |
| 3.0 | 78 | Good processability | Good processability |
| | | during extrusion, | during extrusion, |
| | | Good surface | Good surface |
| | | without yarn | without yarn |
| | | breakage | breakage |
| 5.0 | 70 | Too slippery | Too slippery |
| | | surface and extreme | surface and extreme |
| | | crystallization | crystallization |

TABLE 10

| | TPU composition (100%) | | |
|---|---|---|---|
| | Succinate content (20.0%), Adipate content (23.0%), | | |
| | Glycol content (13.0%), Isocyanate content (44.0%) | | |
| Nano-silica | | Processability | |
| content | Elongation | Multifilament yarn | Monofilament yarn |
| (phr) | (%) | (5 denier, 36 filler) | (150 to 200 denier) |
| 0.0 | 71 | Yarn breakage | Good processability |
| | | (Not working) | during extrusion, |
| | | | Yarn breakage 15% |
| 0.5 | 76 | Good processability | Good processability |
| | | during extrusion, | during extrusion, |
| | | Good surface | Good surface |
| | | without yarn | without yarn |
| | | breakage | breakage |
| 1.0 | 75 | Good processability | Good processability |
| | | during extrusion, | during extrusion, |
| | | Good surface | Good surface |
| | | without yarn | without yarn |
| | | breakage | breakage |
| 2.0 | 78 | Good processability | Good processability |
| | | during extrusion, | during extrusion, |
| | | Good surface | Good surface |
| | | without yarn | without yarn |
| | | breakage | breakage |
| 3.0 | 73 | Good processability | Good processability |
| | | during extrusion, | during extrusion, |
| | | Good surface | Good surface |
| | | without yarn | without yarn |
| | | breakage | breakage |
| 5.0 | 70 | Too slippery | Too slippery |
| | | surface and extreme | surface and extreme |
| | | crystallization | crystallization |

TABLE 11

| | TPU composition (100%) | | |
|---|---|---|---|
| | Succinate content (30.0%), Adipate content (13.0%), | | |
| | Glycol content (13.0%), Isocyanate content (44.0%) | | |
| Nano-silica | | Processability | |
| content | Elongation | Multifilament yarn | Monofilament yarn |
| (phr) | (%) | (5 denier, 36 filler) | (150 to 200 denier) |
| 0.0 | 70 | Yarn breakage | Good processability |
| | | (Not working) | during extrusion, |
| | | | Yarn breakage 15% |
| 0.5 | 73 | Good processability | Good processability |
| | | during extrusion, | during extrusion, |
| | | Good surface | Good surface |
| | | without yarn | without yarn |
| | | breakage | breakage |
| 1.0 | 76 | Good processability | Good processability |
| | | during extrusion, | during extrusion, |
| | | Good surface | Good surface |
| | | without yarn | without yarn |
| | | breakage | breakage |
| 2.0 | 76 | Good processability | Good processability |
| | | during extrusion, | during extrusion, |
| | | Good surface | Good surface |
| | | without yarn | without yarn |
| | | breakage | breakage |
| 3.0 | 74 | Good processability | Good processability |
| | | during extrusion, | during extrusion, |
| | | Good surface | Good surface |
| | | without yarn | without yarn |
| | | breakage | breakage |
| 5.0 | 67 | Too slippery | Too slippery |
| | | surface and extreme | surface and extreme |
| | | crystallization | crystallization |

TABLE 12

| | TPU composition (100%) | | |
|---|---|---|---|
| | Succinate content (40.0%), Adipate content (3.0%), | | |
| | Glycol content (13.0%), Isocyanate content (44.0%) | | |
| Nano-silica | | Processability | |
| content | Elongation | Multifilament yarn | Monofilament yarn |
| (phr) | (%) | (5 denier, 36 filler) | (150 to 200 denier) |
| 0.0 | 68 | Yarn breakage | Good processability |
| | | (Not working) | during extrusion, |
| | | | Yarn breakage 15% |
| 0.5 | 70 | Good processability | Good processability |
| | | during extrusion, | during extrusion, |
| | | Good surface | Good surface |
| | | without yarn | without yarn |
| | | breakage | breakage |
| 1.0 | 73 | Good processability | Good processability |
| | | during extrusion, | during extrusion, |
| | | Good surface | Good surface |
| | | without yarn | without yarn |
| | | breakage | breakage |
| 2.0 | 70 | Good processability | Good processability |
| | | during extrusion, | during extrusion, |
| | | Good surface | Good surface |
| | | without yarn | without yarn |
| | | breakage | breakage |
| 3.0 | 73 | Good processability | Good processability |
| | | during extrusion, | during extrusion, |
| | | Good surface | Good surface |
| | | without yarn | without yarn |
| | | breakage | breakage |
| 5.0 | 65 | Too slippery | Too slippery |
| | | surface and extreme | surface and extreme |
| | | crystallization | crystallization |

TABLE 13

| | TPU composition (100%) | | |
|---|---|---|---|
| | Succinate content (43.0%), Adipate content (0.0%), | | |
| | Glycol content (13.0%), Isocyanate content (44.0%) | | |
| Nano-silica | | Processability | |
| content | Elongation | Multifilament yarn | Monofilament yarn |
| (phr) | (%) | (5 denier, 36 filler) | (150 to 200 denier) |
| 0.0 | 62 | Yarn breakage | Good processability |
| | | (Not working) | during extrusion, |
| | | | Yarn breakage 15% |
| 0.5 | 58 | Yarn breakage | Good processability |
| | | (Not working) | during extrusion, |
| | | | Yarn breakage 15% |
| 1.0 | 61 | Yarn breakage | Too slippery |
| | | (Not working) | surface and extreme |
| | | | crystallization |
| 2.0 | 64 | Too slippery | Too slippery |
| | | surface and extreme | surface and extreme |
| | | crystallization | crystallization |
| 3.0 | 59 | Too slippery | Too slippery |
| | | surface and extreme | surface and extreme |
| | | crystallization | crystallization |
| 5.0 | 55 | Too slippery | Too slippery |
| | | surface and extreme | surface and extreme |
| | | crystallization | crystallization |

As can be seen from Tables 7 to 13, the production of multifilament and monofilament yarns from a thermoplastic polyurethane having a hardness of 60D is impossible to accomplish merely with a succinate content of less than 5% due to low crystallization rate, but successfully realized with a succinate content of 5 to 40% that accelerates the crystallization rate. The succinate content of greater than 40% increases the crystallization rate extremely high, causing yarn breakage too frequently to produce monofilament or multifilament yarns. Meanwhile, the elongation is increased (by about 5 to 20%) with an increase in the succinate content of the thermoplastic polyurethane.

In the present invention, nano-silica is used in combination with succinate in order to prevent yarn breakage during the cooling and drawing processes. For thermoplastic polyurethane having a hardness of 60D, the nano-silica content of 0.5 to 3.0 phr realizes a continuous spinning of yarns without yarn breakage; and the nano-silica content of 5.0 phr results in too slippery surface and extreme crystallization, causing occasional yarn breakage, but no problem in continuously spinning the yarns.

### Example 4

Tables 14 to 21 present the mixing ratios of the individual compositions for production of the thermoplastic polyurethane yarns of the present invention from thermoplastic polyurethane (TPU) having a hardness of 98A. In other words, the following tables specifically show the elongation and processability of the thermoplastic polyurethane yarns with succinate and nano-silica contents under control.

TABLE 14

| | TPU composition (100%) | | |
|---|---|---|---|
| | Succinate content (0.0%), Adipate content (48.5%), | | |
| | Glycol content (10.5%), Isocyanate content (41.0%) | | |
| Nano-silica | | Processability | |
| content | Elongation | Multifilament yarn | Monofilament yarn |
| (phr) | (%) | (5 denier, 36 filler) | (150 to 200 denier) |
| 0.0 | 82 | Yarn breakage | Good processability |
| | | (Not working) | during extrusion, |
| | | | Yarn breakage 20% |
| 0.5 | 86 | Yarn breakage | Good processability |
| | | (Not working) | during extrusion, |
| | | | Yarn breakage 20% |
| 1.0 | 90 | Yarn breakage | Good processability |
| | | (Not working) | during extrusion, |
| | | | Good surface |
| | | | without yarn |
| | | | breakage |
| 2.0 | 94 | Good processability | Good processability |
| | | during extrusion, | during extrusion, |
| | | Yarn breakage 30% | Good surface |
| | | | without yarn |
| | | | breakage |
| 3.0 | 92 | Good processability | Good processability |
| | | during extrusion, | during extrusion, |
| | | Yarn breakage 30% | Good surface |
| | | | without yarn |
| | | | breakage |
| 5.0 | 88 | Good processability | Good processability |
| | | during extrusion, | during extrusion, |
| | | Yarn breakage 30% | Good surface |
| | | | without yarn |
| | | | breakage |

TABLE 15

| | TPU composition (100%) | | |
|---|---|---|---|
| | Succinate content (5.0%), Adipate content (43.5%), | | |
| | Glycol content (10.5%), Isocyanate content (41.0%) | | |
| Nano-silica | | Processability | |
| content | Elongation | Multifilament yarn | Monofilament yarn |
| (phr) | (%) | (5 denier, 36 filler) | (150 to 200 denier) |
| 0.0 | 81 | Yarn breakage | Good processability |
| | | (Not working) | during extrusion, |
| | | | Yarn breakage 20% |
| 0.5 | 86 | Good processability | Good processability |
| | | during extrusion, | during extrusion, |
| | | Good surface | Good surface |
| | | without yarn | without yarn |
| | | breakage | breakage |
| 1.0 | 94 | Good processability | Good processability |
| | | during extrusion, | during extrusion, |
| | | Good surface | Good surface |
| | | without yarn | without yarn |
| | | breakage | breakage |
| 2.0 | 95 | Good processability | Good processability |
| | | during extrusion, | during extrusion, |
| | | Good surface | Good surface |
| | | without yarn | without yarn |
| | | breakage | breakage |
| 3.0 | 93 | Good processability | Good processability |
| | | during extrusion, | during extrusion, |
| | | Good surface | Good surface |
| | | without yarn | without yarn |
| | | breakage | breakage |
| 5.0 | 87 | Too slippery | Too slippery |
| | | surface and extreme | surface and extreme |
| | | crystallization | crystallization |

TABLE 16

| | TPU composition (100%) | | |
|---|---|---|---|
| | Succinate content (10.0%), Adipate content (38.5%), | | |
| | Glycol content (10.5%), Isocyanate content (41.0%) | | |
| Nano-silica | | Processability | |
| content | Elongation | Multifilament yarn | Monofilament yarn |
| (phr) | (%) | (5 denier, 36 filler) | (150 to 200 denier) |
| 0.0 | 89 | Yarn breakage | Good processability |
| | | (Not working) | during extrusion, |
| | | | Yarn breakage 15% |
| 0.5 | 96 | Good processability | Good processability |
| | | during extrusion, | during extrusion, |
| | | Good surface | Good surface |
| | | without yarn | without yarn |
| | | breakage | breakage |
| 1.0 | 101 | Good processability | Good processability |
| | | during extrusion, | during extrusion, |
| | | Good surface | Good surface |
| | | without yarn | without yarn |
| | | breakage | breakage |
| 2.0 | 105 | Good processability | Good processability |
| | | during extrusion, | during extrusion, |
| | | Good surface | Good surface |
| | | without yarn | without yarn |
| | | breakage | breakage |
| 3.0 | 100 | Good processability | Good processability |
| | | during extrusion, | during extrusion, |
| | | Good surface | Good surface |
| | | without yarn | without yarn |
| | | breakage | breakage |
| 5.0 | 98 | Too slippery | Too slippery |
| | | surface and extreme | surface and extreme |
| | | crystallization | crystallization |

TABLE 17

| | TPU composition (100%) | | |
|---|---|---|---|
| | Succinate content (20.0%), Adipate content (28.5%), | | |
| | Glycol content (10.5%), Isocyanate content (41.0%) | | |
| Nano-silica | | Processability | |
| content | Elongation | Multifilament yarn | Monofilament yarn |
| (phr) | (%) | (5 denier, 36 filler) | (150 to 200 denier) |
| 0.0 | 94 | Yarn breakage | Good processability |
| | | (Not working) | during extrusion, |
| | | | Yarn breakage 15% |
| 0.5 | 97 | Good processability | Good processability |
| | | during extrusion, | during extrusion, |
| | | Good surface | Good surface |
| | | without yarn | without yarn |
| | | breakage | breakage |
| 1.0 | 106 | Good processability | Good processability |
| | | during extrusion, | during extrusion, |
| | | Good surface | Good surface |
| | | without yarn | without yarn |
| | | breakage | breakage |
| 2.0 | 108 | Good processability | Good processability |
| | | during extrusion, | during extrusion, |
| | | Good surface | Good surface |
| | | without yarn | without yarn |
| | | breakage | breakage |
| 3.0 | 100 | Good processability | Good processability |
| | | during extrusion, | during extrusion, |
| | | Good surface | Good surface |
| | | without yarn | without yarn |
| | | breakage | breakage |
| 5.0 | 95 | Too slippery | Too slippery |
| | | surface and extreme | surface and extreme |
| | | crystallization | crystallization |

TABLE 18

| | TPU composition (100%) | | |
|---|---|---|---|
| | Succinate content (30.0%), Adipate content (18.5%), | | |
| | Glycol content (10.5%), Isocyanate content (41.0%) | | |
| Nano-silica | | Processability | |
| content | Elongation | Multifilament yarn | Monofilament yarn |
| (phr) | (%) | (5 denier, 36 filler) | (150 to 200 denier) |
| 0.0 | 92 | Yarn breakage | Good processability |
| | | (Not working) | during extrusion, |
| | | | Yarn breakage 10% |
| 0.5 | 96 | Good processability | Good processability |
| | | during extrusion, | during extrusion, |
| | | Good surface | Good surface |
| | | without yarn | without yarn |
| | | breakage | breakage |
| 1.0 | 101 | Good processability | Good processability |
| | | during extrusion, | during extrusion, |
| | | Good surface | Good surface |
| | | without yarn | without yarn |
| | | breakage | breakage |
| 2.0 | 103 | Good processability | Good processability |
| | | during extrusion, | during extrusion, |
| | | Good surface | Good surface |
| | | without yarn | without yarn |
| | | breakage | breakage |
| 3.0 | 100 | Good processability | Good processability |
| | | during extrusion, | during extrusion, |
| | | Good surface | Good surface |
| | | without yarn | without yarn |
| | | breakage | breakage |
| 5.0 | 96 | Too slippery | Too slippery |
| | | surface and extreme | surface and extreme |
| | | crystallization | crystallization |

TABLE 19

| | TPU composition (100%) | | |
|---|---|---|---|
| | Succinate content (40.0%), Adipate content (8.5%), | | |
| | Glycol content (10.5%), Isocyanate content (41.0%) | | |
| Nano-silica | | Processability | |
| content | Elongation | Multifilament yarn | Monofilament yarn |
| (phr) | (%) | (5 denier, 36 filler) | (150 to 200 denier) |
| 0.0 | 93 | Yarn breakage | Good processability |
| | | (Not working) | during extrusion, |
| | | | Yarn breakage 10% |
| 0.5 | 98 | Good processability | Good processability |
| | | during extrusion, | during extrusion, |
| | | Good surface | Good surface |
| | | without yarn | without yarn |
| | | breakage | breakage |
| 1.0 | 103 | Good processability | Good processability |
| | | during extrusion, | during extrusion, |
| | | Good surface | Good surface |
| | | without yarn | without yarn |
| | | breakage | breakage |
| 2.0 | 106 | Good processability | Good processability |
| | | during extrusion, | during extrusion, |
| | | Good surface | Good surface |
| | | without yarn | without yarn |
| | | breakage | breakage |
| 3.0 | 103 | Good processability | Good processability |
| | | during extrusion, | during extrusion, |
| | | Good surface | Good surface |
| | | without yarn | without yarn |
| | | breakage | breakage |
| 5.0 | 95 | Too slippery | Too slippery |
| | | surface and extreme | surface and extreme |
| | | crystallization | crystallization |

TABLE 20

| | TPU composition (100%) | | |
|---|---|---|---|
| | Succinate content (45.0%), Adipate content (3.5%), | | |
| | Glycol content (10.5%), Isocyanate content (41.0%) | | |
| Nano-silica | | Processability | |
| content | Elongation | Multifilament yarn | Monofilament yarn |
| (phr) | (%) | (5 denier, 36 filler) | (150 to 200 denier) |
| 0.0 | 97 | Yarn breakage | Good processability |
| | | (Not working) | during extrusion, |
| | | | Yarn breakage 10% |
| 0.5 | 100 | Good processability | Good processability |
| | | during extrusion, | during extrusion, |
| | | Good surface | Good surface |
| | | without yarn | without yarn |
| | | breakage | breakage |
| 1.0 | 106 | Good processability | Good processability |
| | | during extrusion, | during extrusion, |
| | | Good surface | Good surface |
| | | without yarn | without yarn |
| | | breakage | breakage |
| 2.0 | 105 | Good processability | Good processability |
| | | during extrusion, | during extrusion, |
| | | Good surface | Good surface |
| | | without yarn | without yarn |
| | | breakage | breakage |
| 3.0 | 102 | Good processability | Good processability |
| | | during extrusion, | during extrusion, |
| | | Good surface | Good surface |
| | | without yarn | without yarn |
| | | breakage | breakage |
| 5.0 | 100 | Too slippery | Too slippery |
| | | surface and extreme | surface and extreme |
| | | crystallization | crystallization |

TABLE 21

| | TPU composition (100%) | | |
|---|---|---|---|
| | Succinate content (48.5%), Adipate content (0.0%), | | |
| | Glycol content (10.5%), Isocyanate content (41.0%) | | |
| Nano-silica | | Processability | |
| content | Elongation | Multifilament yarn | Monofilament yarn |
| (phr) | (%) | (5 denier, 36 filler) | (150 to 200 denier) |
| 0.0 | 92 | Yarn breakage | Good processability |
| | | (Not working) | during extrusion, |
| | | | Yarn breakage 15% |
| 0.5 | 95 | Yarn breakage | Good processability |
| | | (Not working) | during extrusion, |
| | | | Yarn breakage 15% |
| 1.0 | 95 | Yarn breakage | Too slippery |
| | | (Not working) | surface and extreme |
| | | | crystallization |
| 2.0 | 94 | Too slippery | Too slippery |
| | | surface and extreme | surface and extreme |
| | | crystallization | crystallization |
| 3.0 | 90 | Too slippery | Too slippery |
| | | surface and extreme | surface and extreme |
| | | crystallization | crystallization |
| 5.0 | 89 | Too slippery | Too slippery |
| | | surface and extreme | surface and extreme |
| | | crystallization | crystallization |

As can be seen from Tables 14 to 21, the production of multifilament and monofilament yarns from a thermoplastic polyurethane having a hardness of 98A is impossible to accomplish merely with a succinate content of less than 5% due to low crystallization rate, but successfully realized with a succinate content of 5 to 45% that accelerates the crystallization rate. The succinate content of greater than 45% increases the crystallization rate extremely high, causing yarn breakage too frequently to produce monofilament or multifilament yarns. Particularly, although low-hardness (Shore 98A) thermoplastic polyurethane is used in the production of thermoplastic polyurethane yarns, it is possible not only to impart great stretch and recovery but also to realize a continuous spinning of yarns without yarn breakage during the cooling and drawing processes. Meanwhile, the elongation is increased (by about 5 to 20%) with an increase in the succinate content of the thermoplastic polyurethane.

In the present invention, nano-silica is used in combination with succinate in order to prevent yarn breakage during the cooling and drawing processes. For thermoplastic polyurethane having a hardness of 98A, the nano-silica content of 0.5 to 3.0 phr realizes a continuous spinning of yarns without yarn breakage; and the nano-silica content of 5.0 phr results in too slippery surface and extreme crystallization, causing occasional yarn breakage, but no problem in continuously spinning the yarns.

### Example 5

Tables 22 to 29 present the mixing ratios of the individual compositions for production of the thermoplastic polyurethane yarns of the present invention from thermoplastic polyurethane (TPU) having a hardness of 90A. In other words, the following tables specifically show the elongation and processability of the thermoplastic polyurethane yarns with succinate and nano-silica contents under control.

TABLE 22

| | TPU composition (100%) | | |
|---|---|---|---|
| | Succinate content (5.0%), Adipate content (56.0%), | | |
| | Glycol content (6.5%), Isocyanate content (32.5%) | | |
| Nano-silica | | Processability | |
| content | Elongation | Multifilament yarn | Monofilament yarn |
| (phr) | (%) | (5 denier, 36 filler) | (150 to 200 denier) |
| 0.0 | 156 | Yarn breakage | Good processability |
| | | (Not working) | during extrusion, |
| | | | Yarn breakage 50% |
| 0.5 | 162 | Yarn breakage | Good processability |
| | | (Not working) | during extrusion, |
| | | | Yarn breakage 25% |
| 1.0 | 168 | Yarn breakage | Good processability |
| | | (Not working) | during extrusion, |
| | | | Yarn breakage 25% |
| 2.0 | 172 | Good processability | Good processability |
| | | during extrusion, | during extrusion, |
| | | Yarn breakage 30% | Yarn breakage 25% |
| 3.0 | 165 | Good processability | Good processability |
| | | during extrusion, | during extrusion, |
| | | Yarn breakage 30% | Yarn breakage 15% |
| 5.0 | 164 | Good processability | Good processability |
| | | during extrusion, | during extrusion, |
| | | Yarn breakage 30% | Yarn breakage 15% |

TABLE 23

| | TPU composition (100%) | | |
|---|---|---|---|
| | Succinate content (10.0%), Adipate content (51.0%), | | |
| | Glycol content (6.5%), Isocyanate content (32.5%) | | |
| Nano-silica | | Processability | |
| content | Elongation | Multifilament yarn | Monofilament yarn |
| (phr) | (%) | (5 denier, 36 filler) | (150 to 200 denier) |
| 0.0 | 163 | Yarn breakage | Good processability |
| | | (Not working) | during extrusion, |
| | | | Yarn breakage 20% |
| 0.5 | 169 | Good processability | Good processability |
| | | during extrusion, | during extrusion, |
| | | Good surface | Good surface |
| | | without yarn | without yarn |
| | | breakage | breakage |
| 1.0 | 175 | Good processability | Good processability |
| | | during extrusion, | during extrusion, |
| | | Good surface | Good surface |
| | | without yarn | without yarn |
| | | breakage | breakage |
| 2.0 | 173 | Good processability | Good processability |
| | | during extrusion, | during extrusion, |
| | | Good surface | Good surface |
| | | without yarn | without yarn |
| | | breakage | breakage |
| 3.0 | 176 | Good processability | Good processability |
| | | during extrusion, | during extrusion, |
| | | Good surface | Good surface |
| | | without yarn | without yarn |
| | | breakage | breakage |
| 5.0 | 170 | Too slippery | Too slippery |
| | | surface and extreme | surface and extreme |
| | | crystallization | crystallization |

TABLE 24

| | TPU composition (100%) | | |
|---|---|---|---|
| | Succinate content (20.0%), Adipate content (41.0%), | | |
| | Glycol content (6.5%), Isocyanate content (32.5%) | | |
| Nano-silica | | Processability | |
| content | Elongation | Multifilament yarn | Monofilament yarn |
| (phr) | (%) | (5 denier, 36 filler) | (150 to 200 denier) |
| 0.0 | 170 | Yarn breakage | Good processability |
| | | (Not working) | during extrusion, |
| | | | Yarn breakage 15% |
| 0.5 | 173 | Good processability | Good processability |
| | | during extrusion, | during extrusion, |
| | | Good surface | Good surface |
| | | without yarn | without yarn |
| | | breakage | breakage |
| 1.0 | 182 | Good processability | Good processability |
| | | during extrusion, | during extrusion, |
| | | Good surface | Good surface |
| | | without yarn | without yarn |
| | | breakage | breakage |
| 2.0 | 186 | Good processability | Good processability |
| | | during extrusion, | during extrusion, |
| | | Good surface | Good surface |
| | | without yarn | without yarn |
| | | breakage | breakage |
| 3.0 | 182 | Good processability | Good processability |
| | | during extrusion, | during extrusion, |
| | | Good surface | Good surface |
| | | without yarn | without yarn |
| | | breakage | breakage |
| 5.0 | 182 | Too slippery | Too slippery |
| | | surface and extreme | surface and extreme |
| | | crystallization | crystallization |

TABLE 25

| | TPU composition (100%) | | |
|---|---|---|---|
| | Succinate content (30.0%), Adipate content (31.0%), | | |
| | Glycol content (6.5%), Isocyanate content (32.5%) | | |
| Nano-silica | | Processability | |
| content | Elongation | Multifilament yarn | Monofilament yarn |
| (phr) | (%) | (5 denier, 36 filler) | (150 to 200 denier) |
| 0.0 | 176 | Yarn breakage | Good processability |
| | | (Not working) | during extrusion, |
| | | | Yarn breakage 15% |
| 0.5 | 186 | Good processability | Good processability |
| | | during extrusion, | during extrusion, |
| | | Good surface | Good surface |
| | | without yarn | without yarn |
| | | breakage | breakage |
| 1.0 | 193 | Good processability | Good processability |
| | | during extrusion, | during extrusion, |
| | | Good surface | Good surface |
| | | without yarn | without yarn |
| | | breakage | breakage |
| 2.0 | 192 | Good processability | Good processability |
| | | during extrusion, | during extrusion, |
| | | Good surface | Good surface |
| | | without yarn | without yarn |
| | | breakage | breakage |
| 3.0 | 193 | Good processability | Good processability |
| | | during extrusion, | during extrusion, |
| | | Good surface | Good surface |
| | | without yarn | without yarn |
| | | breakage | breakage |
| 5.0 | 189 | Too slippery | Too slippery |
| | | surface and extreme | surface and extreme |
| | | crystallization | crystallization |

TABLE 26

| | TPU composition (100%) | | |
|---|---|---|---|
| | Succinate content (40.0%), Adipate content (21.0%), | | |
| | Glycol content (6.5%), Isocyanate content (32.5%) | | |
| Nano-silica | | Processability | |
| content | Elongation | Multifilament yarn | Monofilament yarn |
| (phr) | (%) | (5 denier, 36 filler) | (150 to 200 denier) |
| 0.0 | 181 | Yarn breakage | Good processability |
| | | (Not working) | during extrusion, |
| | | | Yarn breakage 10% |
| 0.5 | 183 | Good processability | Good processability |
| | | during extrusion, | during extrusion, |
| | | Good surface | Good surface |
| | | without yarn | without yarn |
| | | breakage | breakage |
| 1.0 | 182 | Good processability | Good processability |
| | | during extrusion, | during extrusion, |
| | | Good surface | Good surface |
| | | without yarn | without yarn |
| | | breakage | breakage |
| 2.0 | 179 | Good processability | Good processability |
| | | during extrusion, | during extrusion, |
| | | Good surface | Good surface |
| | | without yarn | without yarn |
| | | breakage | breakage |
| 3.0 | 178 | Good processability | Good processability |
| | | during extrusion, | during extrusion, |
| | | Good surface | Good surface |
| | | without yarn | without yarn |
| | | breakage | breakage |
| 5.0 | 176 | Too slippery | Too slippery |
| | | surface and extreme | surface and extreme |
| | | crystallization | crystallization |

TABLE 27

| | TPU composition (100%) | | |
|---|---|---|---|
| | Succinate content (50.0%), Adipate content (11.0%), | | |
| | Glycol content (6.5%), Isocyanate content (32.5%) | | |
| Nano-silica | | Processability | |
| content | Elongation | Multifilament yarn | Monofilament yarn |
| (phr) | (%) | (5 denier, 36 filler) | (150 to 200 denier) |
| 0.0 | 180 | Yarn breakage | Good processability |
| | | (Not working) | during extrusion, |
| | | | Yarn breakage 10% |
| 0.5 | 182 | Good processability | Good processability |
| | | during extrusion, | during extrusion, |
| | | Good surface | Good surface |
| | | without yarn | without yarn |
| | | breakage | breakage |
| 1.0 | 186 | Good processability | Good processability |
| | | during extrusion, | during extrusion, |
| | | Good surface | Good surface |
| | | without yarn | without yarn |
| | | breakage | breakage |
| 2.0 | 179 | Good processability | Good processability |
| | | during extrusion, | during extrusion, |
| | | Good surface | Good surface |
| | | without yarn | without yarn |
| | | breakage | breakage |
| 3.0 | 176 | Good processability | Good processability |
| | | during extrusion, | during extrusion, |
| | | Good surface | Good surface |
| | | without yarn | without yarn |
| | | breakage | breakage |
| 5.0 | 170 | Too slippery | Too slippery |
| | | surface and extreme | surface and extreme |
| | | crystallization | crystallization |

TABLE 28

| | TPU composition (100%) | | |
|---|---|---|---|
| | Succinate content (55.0%), Adipate content (6.0%), | | |
| | Glycol content (6.5%), Isocyanate content (32.5%) | | |
| Nano-silica | | Processability | |
| content | Elongation | Multifilament yarn | Monofilament yarn |
| (phr) | (%) | (5 denier, 36 filler) | (150 to 200 denier) |
| 0.0 | 182 | Yarn breakage | Good processability |
| | | (Not working) | during extrusion, |
| | | | Yarn breakage 10% |
| 0.5 | 183 | Good processability | Good processability |
| | | during extrusion, | during extrusion, |
| | | Good surface | Good surface |
| | | without yarn | without yarn |
| | | breakage | breakage |
| 1.0 | 180 | Good processability | Good processability |
| | | during extrusion, | during extrusion, |
| | | Good surface | Good surface |
| | | without yarn | without yarn |
| | | breakage | breakage |
| 2.0 | 182 | Good processability | Good processability |
| | | during extrusion, | during extrusion, |
| | | Good surface | Good surface |
| | | without yarn | without yarn |
| | | breakage | breakage |
| 3.0 | 185 | Good processability | Good processability |
| | | during extrusion, | during extrusion, |
| | | Good surface | Good surface |
| | | without yarn | without yarn |
| | | breakage | breakage |
| 5.0 | 172 | Too slippery | Too slippery |
| | | surface and extreme | surface and extreme |
| | | crystallization | crystallization |

TABLE 29

| | TPU composition (100%) | | |
|---|---|---|---|
| | Succinate content (61.0%), Adipate content (0.0%), | | |
| | Glycol content (6.5%), Isocyanate content (32.5%) | | |
| Nano-silica | | Processability | |
| content | Elongation | Multifilament yarn | Monofilament yarn |
| (phr) | (%) | (5 denier, 36 filler) | (150 to 200 denier) |
| 0.0 | 172 | Yarn breakage | Good processability |
| | | (Not working) | during extrusion, |
| | | | Yarn breakage 15% |
| 0.5 | 182 | Yarn breakage | Good processability |
| | | (Not working) | during extrusion, |
| | | | Yarn breakage 15% |
| 1.0 | 183 | Yarn breakage | Good processability |
| | | (Not working) | during extrusion, |
| | | | Yarn breakage 20% |
| 2.0 | 179 | Yarn breakage | Good processability |
| | | (Not working) | during extrusion, |
| | | | Yarn breakage 25% |
| 3.0 | 175 | Yarn breakage | Too slippery |
| | | (Not working) | surface and extreme |
| | | | crystallization |
| 5.0 | 174 | Too slippery | Too slippery |
| | | surface and extreme | surface and extreme |
| | | crystallization | crystallization |

As can be seen from Tables 22 to 29, the production of multifilament and monofilament yarns from a thermoplastic polyurethane having a hardness of 90A is impossible to accomplish merely with a succinate content of less than 10% due to low crystallization rate, but successfully realized with a succinate content of 10 to 55% that accelerates the crystallization rate. The succinate content of greater than 55% increases the crystallization rate extremely high, causing yarn breakage too frequently to produce monofilament or multifilament yarns. Particularly, although low-hardness (Shore 90A) thermoplastic polyurethane is used in the production of thermoplastic polyurethane yarns, it is possible not only to impart great stretch and recovery but also to realize a continuous spinning of yarns without yarn breakage during the cooling and drawing processes. Meanwhile, the elongation is increased (by about 5 to 20%) with an increase in the succinate content of the thermoplastic polyurethane.

In the present invention, nano-silica is used in combination with succinate in order to prevent yarn breakage during the cooling and drawing processes. For thermoplastic polyurethane having a hardness of 90A, the nano-silica content of 0.5 to 3.0 phr realizes a continuous spinning of yarns without yarn breakage; and the nano-silica content of 5.0 phr results in too slippery surface and extreme crystallization, causing occasional yarn breakage, but no problem in continuously spinning the yarns.

### Example 6

Tables 30 to 38 present the mixing ratios of the individual compositions for production of the thermoplastic polyurethane yarns of the present invention from thermoplastic polyurethane (TPU) having a hardness of 70A. In other words, the following tables specifically show the elongation and processability of the thermoplastic polyurethane yarns with succinate and nano-silica contents under control.

TABLE 30

| | TPU composition (100%) | | |
|---|---|---|---|
| | Succinate content (15.0%), Adipate content (62.5%), | | |
| | Glycol content (2.5%), Isocyanate content (20.0%) | | |
| Nano-silica | | Processability | |
| content | Elongation | Multifilament yarn | Monofilament yarn |
| (phr) | (%) | (5 denier, 36 filler) | (150 to 200 denier) |
| 0.0 | 254 | Yarn breakage | Good processability |
| | | (Not working) | during extrusion, |
| | | | Yarn breakage 50% |
| 0.5 | 248 | Yarn breakage | Good processability |
| | | (Not working) | during extrusion, |
| | | | Yarn breakage 50% |
| 1.0 | 257 | Yarn breakage | Good processability |
| | | (Not working) | during extrusion, |
| | | | Yarn breakage 30% |
| 2.0 | 258 | Yarn breakage | Good processability |
| | | (Not working) | during extrusion, |
| | | | Yarn breakage 30% |
| 3.0 | 256 | Yarn breakage | Good processability |
| | | (Not working) | during extrusion, |
| | | | Yarn breakage 30% |
| 5.0 | 247 | Yarn breakage | Good processability |
| | | (Not working) | during extrusion, |
| | | | Yarn breakage 30% |

TABLE 31

| | TPU composition (100%) | | |
|---|---|---|---|
| | Succinate content (20.0%), Adipate content (57.5%), | | |
| | Glycol content (2.5%), Isocyanate content (20.0%) | | |
| | | Processability | |
| Nano-silica | Elongation | Multifilament yarn | Monofilament yarn |
| content | (%) | (5 denier, 36 filler) | (150 to 200 denier) |
| 0.0 | 258 | Yarn breakage | Good processability |
| | | (Not working) | during extrusion, |
| | | | Yarn breakage 30% |
| 0.5 | 255 | Yarn breakage | Good processability |
| | | (Not working) | during extrusion, |
| | | | Yarn breakage 15% |
| 1.0 | 261 | Yarn breakage | Good processability |
| | | (Not working) | during extrusion, |
| | | | Good surface |
| | | | without yarn |
| | | | breakage |
| 2.0 | 264 | Good processability | Good processability |
| | | during extrusion, | during extrusion, |
| | | Good surface | Good surface |
| | | without yarn | without yarn |
| | | breakage | breakage |
| 3.0 | 261 | Good processability | Good processability |
| | | during extrusion, | during extrusion, |
| | | Good surface | Good surface |
| | | without yarn | without yarn |
| | | breakage | breakage |
| 5.0 | 254 | Good processability | Good processability |
| | | during extrusion, | during extrusion, |
| | | Good surface | Good surface |
| | | without yarn | without yarn |
| | | breakage | breakage |

TABLE 32

| | TPU composition (100%) | | |
|---|---|---|---|
| | Succinate content (30.0%), Adipate content (47.5%), | | |
| | Glycol content (2.5%), Isocyanate content (20.0%) | | |
| Nano-silica | | Processability | |
| content | Elongation | Multifilament yarn | Monofilament yarn |
| (phr) | (%) | (5 denier, 36 filler) | (150 to 200 denier) |
| 0.0 | 251 | Yarn breakage | Good processability |
| | | (Not working) | during extrusion, |
| | | | Yarn breakage 20% |
| 0.5 | 261 | Yarn breakage | Good processability |
| | | (Not working) | during extrusion, |
| | | | Good surface |
| | | | without yarn |
| | | | breakage |
| 1.0 | 264 | Good processability | Good processability |
| | | during extrusion, | during extrusion, |
| | | Good surface | Good surface |
| | | without yarn | without yarn |
| | | breakage | breakage |
| 2.0 | 266 | Good processability | Good processability |
| | | during extrusion, | during extrusion, |
| | | Good surface | Good surface |
| | | without yarn | without yarn |
| | | breakage | breakage |
| 3.0 | 267 | Good processability | Good processability |
| | | during extrusion, | during extrusion, |
| | | Good surface | Good surface |
| | | without yarn | without yarn |
| | | breakage | breakage |
| 5.0 | 260 | Good processability | Good processability |
| | | during extrusion, | during extrusion, |
| | | Good surface | Good surface |
| | | without yarn | without yarn |
| | | breakage | breakage |

TABLE 33

| | TPU composition (100%) | | |
|---|---|---|---|
| | Succinate content (40.0%), Adipate content (37.5%), | | |
| | Glycol content (2.5%), Isocyanate content (20.0%) | | |
| Nano-silica | | Processability | |
| content | Elongation | Multifilament yarn | Monofilament yarn |
| (phr) | (%) | (5 denier, 36 filler) | (150 to 200 denier) |
| 0.0 | 268 | Yarn breakage | Good processability |
| | | (Not working) | during extrusion, |
| | | | Yarn breakage 20% |
| 0.5 | 270 | Good processability | Good processability |
| | | during extrusion, | during extrusion, |
| | | Good surface | Good surface |
| | | without yarn | without yarn |
| | | breakage | breakage |
| 1.0 | 283 | Good processability | Good processability |
| | | during extrusion, | during extrusion, |
| | | Good surface | Good surface |
| | | without yarn | without yarn |
| | | breakage | breakage |
| 2.0 | 291 | Good processability | Good processability |
| | | during extrusion, | during extrusion, |
| | | Good surface | Good surface |
| | | without yarn | without yarn |
| | | breakage | breakage |
| 3.0 | 287 | Good processability | Good processability |
| | | during extrusion, | during extrusion, |
| | | Good surface | Good surface |
| | | without yarn | without yarn |
| | | breakage | breakage |
| 5.0 | 283 | Good processability | Good processability |
| | | during extrusion, | during extrusion, |
| | | Good surface | Good surface |
| | | without yarn | without yarn |
| | | breakage | breakage |

TABLE 34

| | TPU composition (100%) | | |
|---|---|---|---|
| | Succinate content (50.0%), Adipate content (27.5%), | | |
| | Glycol content (2.5%), Isocyanate content (20.0%) | | |
| Nano-silica | | Processability | |
| content | Elongation | Multifilament yarn | Monofilament yarn |
| (phr) | (%) | (5 denier, 36 filler) | (150 to 200 denier) |
| 0.0 | 276 | Yarn breakage | Good processability |
| | | (Not working) | during extrusion, |
| | | | Yarn breakage 15% |
| 0.5 | 291 | Good processability | Good processability |
| | | during extrusion, | during extrusion, |
| | | Good surface | Good surface |
| | | without yarn | without yarn |
| | | breakage | breakage |
| 1.0 | 289 | Good processability | Good processability |
| | | during extrusion, | during extrusion, |
| | | Good surface | Good surface |
| | | without yarn | without yarn |
| | | breakage | breakage |
| 2.0 | 298 | Good processability | Good processability |
| | | during extrusion, | during extrusion, |
| | | Good surface | Good surface |
| | | without yarn | without yarn |
| | | breakage | breakage |
| 3.0 | 290 | Good processability | Good processability |
| | | during extrusion, | during extrusion, |
| | | Good surface | Good surface |
| | | without yarn | without yarn |
| | | breakage | breakage |
| 5.0 | 283 | Good processability | Good processability |
| | | during extrusion, | during extrusion, |
| | | Good surface | Good surface |
| | | without yarn | without yarn |
| | | breakage | breakage |

TABLE 35

| TPU | Succinate content (60.0%), Adipate content (17.5%), | | |
|---|---|---|---|
| composition | Glycol content (2.5%), Isocyanate content (20.0%) | | |
| (100%) | | Processability | |
| Nano-silica | | Multifilament yarn | |
| content | Elongation | (5 denier, 36 | Monofilament yarn |
| (phr) | (%) | filler) | (150 to 200 denier) |
| 0.0 | 284 | Yarn breakage | Good processability |
| | | (Not working) | during extrusion, |
| | | | Yarn breakage 15% |
| 0.5 | 296 | Good | Good processability |
| | | processability | during extrusion, |
| | | during extrusion, | Good surface |
| | | Good surface | without yarn |
| | | without yarn | breakage |
| | | breakage | |
| 1.0 | 299 | Good | Good processability |
| | | processability | during extrusion, |
| | | during extrusion, | Good surface |
| | | Good surface | without yarn |
| | | without yarn | breakage |
| | | breakage | |
| 2.0 | 311 | Good | Good processability |
| | | processability | during extrusion, |
| | | during extrusion, | Good surface |
| | | Good surface | without yarn |
| | | without yarn | breakage |
| | | breakage | |
| 3.0 | 306 | Good | Good processability |
| | | processability | during extrusion, |
| | | during extrusion, | Good surface |
| | | Good surface | without yarn |
| | | without yarn | breakage |
| | | breakage | |
| 5.0 | 291 | Good | Good processability |
| | | processability | during extrusion, |
| | | during extrusion, | Good surface |
| | | Good surface | without yarn |
| | | without yarn | breakage |
| | | breakage | |

TABLE 36

| TPU | Succinate content (70.0%), Adipate content (7.5%), | | |
|---|---|---|---|
| composition | Glycol content (2.5%), Isocyanate content (20.0%) | | |
| (100%) | | Processability | |
| Nano-silica | | Multifilament yarn | |
| content | Elongation | (5 denier, 36 | Monofilament yarn |
| (phr) | (%) | filler) | (150 to 200 denier) |
| 0.0 | 301 | Yarn breakage | Good processability |
| | | (Not working) | during extrusion, |
| | | | Yarn breakage 15% |
| 0.5 | 297 | Good | Good processability |
| | | processability | during extrusion, |
| | | during extrusion, | Good surface |
| | | Good surface | without yarn |
| | | without yarn | breakage |
| | | breakage | |
| 1.0 | 316 | Good | Good processability |
| | | processability | during extrusion, |
| | | during extrusion, | Good surface |
| | | Good surface | without yarn |
| | | without yarn | breakage |
| | | breakage | |
| 2.0 | 310 | Good | Good processability |
| | | processability | during extrusion, |
| | | during extrusion, | Good surface |
| | | Good surface | without yarn |
| | | without yarn | breakage |
| | | breakage | |
| 3.0 | 317 | Good | Good processability |
| | | processability | during extrusion, |
| | | during extrusion, | Good surface |
| | | Good surface | without yarn |
| | | without yarn | breakage |
| | | breakage | |
| 5.0 | 311 | Good | Good processability |
| | | processability | during extrusion, |
| | | during extrusion, | Good surface |
| | | Good surface | without yarn |
| | | without yarn | breakage |
| | | breakage | |

TABLE 37

| TPU | Succinate content (75.0%), Adipate content (2.5%), | | |
|---|---|---|---|
| composition | Glycol content (2.5%), Isocyanate content (20.0%) | | |
| (100%) | | Processability | |
| Nano-silica | | Multifilament yarn | |
| content | Elongation | (5 denier, 36 | Monofilament yarn |
| (phr) | (%) | filler) | (150 to 200 denier) |
| 0.0 | 289 | Yarn breakage | Good processability |
| | | (Not working) | during extrusion, |
| | | | Yarn breakage 10% |
| 0.5 | 294 | Good | Good processability |
| | | processability | during extrusion, |
| | | during extrusion, | Good surface |
| | | Good surface | without yarn |
| | | without yarn | breakage |
| | | breakage | |
| 1.0 | 291 | Good | Good processability |
| | | processability | during extrusion, |
| | | during extrusion, | Good surface |
| | | Good surface | without yarn |
| | | without yarn | breakage |
| | | breakage | |
| 2.0 | 289 | Good | Good processability |
| | | processability | during extrusion, |
| | | during extrusion, | Good surface |
| | | Good surface | without yarn |
| | | without yarn | breakage |
| | | breakage | |
| 3.0 | 293 | Good | Good processability |
| | | processability | during extrusion, |
| | | during extrusion, | Good surface |
| | | Good surface | without yarn |
| | | without yarn | breakage |
| | | breakage | |
| 5.0 | 288 | Good | Good processability |
| | | processability | during extrusion, |
| | | during extrusion, | Good surface |
| | | Good surface | without yarn |
| | | without yarn | breakage |
| | | breakage | |

TABLE 38

| TPU | Succinate content (77.5%), Adipate content (0.0%), | | |
|---|---|---|---|
| composition | Glycol content (2.5%), Isocyanate content (20.0%) | | |
| (100%) | | Processability | |
| Nano-silica | | Multifilament yarn | |
| content | Elongation | (5 denier, 36 | Monofilament yarn |
| (phr) | (%) | filler) | (150 to 200 denier) |
| 0.0 | 273 | Yarn breakage | Good processability |
| | | (Not working) | during extrusion, |
| | | | Yarn breakage 20% |
| 0.5 | 288 | Yarn breakage | Good processability |
| | | (Not working) | during extrusion, |
| | | | Yarn breakage 20% |
| 1.0 | 277 | Yarn breakage | Good processability |
| | | (Not working) | during extrusion, |
| | | | Yarn breakage 20% |
| 2.0 | 279 | Yarn breakage | Good processability |
| | | (Not working) | during extrusion, |
| | | | Yarn breakage 30% |
| 3.0 | 286 | Yarn breakage | Good processability |
| | | (Not working) | during extrusion, |
| | | | Yarn breakage 30% |
| 5.0 | 291 | Too slippery | Good processability |
| | | surface and | during extrusion, |
| | | extreme | Yarn breakage 30% |
| | | crystallization | |

As can be seen from Tables 30 to 38, the production of multifilament and monofilament yarns from a thermoplastic polyurethane having a hardness of 70A is impossible to accomplish merely with a succinate content of less than 20% due to low crystallization rate, but successfully realized with a succinate content of 20 to 75% that accelerates the crystallization rate. The succinate content of greater than 75% increases the crystallization rate extremely high, causing yarn breakage too frequently to produce monofilament or multifilament yarns. Particularly, although low-hardness (Shore 70A) thermoplastic polyurethane is used in the production of thermoplastic polyurethane yarns, it is possible not only to impart great stretch and recovery but also to realize a continuous spinning of yarns without yarn breakage during the cooling and drawing processes. Meanwhile, the elongation is increased (by about 5 to 20%) with an increase in the succinate content of the thermoplastic polyurethane.

In the present invention, nano-silica is used in combination with succinate in order to prevent yarn breakage during the cooling and drawing processes. For thermoplastic polyurethane having a hardness of 70A, the nano-silica content of 0.5 to 5.0 phr realizes a continuous spinning of yarns without yarn breakage.

Table 39 presents the conditions of the melt extrusion process in the production of the novel monofilament yarn from the thermoplastic polyurethane (succinate content 20%, refer to Table 4) having a hardness of 75D.

TABLE 39

| | | | |
|---|---|---|---|
| Extruder (° C.) | Cylinder | C1 | 215 |
| | | C2 | 215 |
| | | C3 | 218 |

| | | |
|---|---|---|
| | Adapter | 215 |
| | Pump (G/P) | 220 |
| | Dies | 235 |
| Cooling section (° C.) | Cooling water | 20 |
| Drawing section | Roll (G/R1) | 40 |
| (rpm) | Roll (G/R2) | 200 |
| Aging section (° C.) | | 100 |

| | |
|---|---|
| Winding section (rpm) | 200 |

Table 40 presents the conditions of the melt extrusion process in the production of the novel monofilament yarn from the thermoplastic polyurethane (succinate content 20%, refer to Table 10) having a hardness of 60D.

TABLE 40

| | | | |
|---|---|---|---|
| Extruder (° C.) | Cylinder | C1 | 205 |
| | | C2 | 205 |
| | | C3 | 210 |

| | | |
|---|---|---|
| | Adapter | 210 |
| | Pump (G/P) | 210 |
| | Dies | 230 |
| Cooling section (° C.) | Cooling water | 20 |
| Drawing section | Roll (G/R1) | 40 |
| (rpm) | Roll (G/R2) | 200 |
| Aging section (° C.) | | 100 |

| | |
|---|---|
| Winding section (rpm) | 200 |

Table 41 presents the conditions of the melt extrusion process in the production of the novel monofilament yarn from the thermoplastic polyurethane (succinate content 20%, refer to Table 17) having a hardness of 98A.

TABLE 41

| | | | |
|---|---|---|---|
| Extruder (° C.) | Cylinder | C1 | 195 |
| | | C2 | 195 |
| | | C3 | 200 |

| | | |
|---|---|---|
| | Adapter | 200 |
| | Pump (G/P) | 203 |
| | Dies | 220 |
| Cooling section (° C.) | Cooling water | 20 |
| Drawing section | Roll (G/R1) | 40 |
| (rpm) | Roll (G/R2) | 200 |
| Aging section (° C.) | | 90 |

| | |
|---|---|
| Winding section (rpm) | 200 |

Table 42 presents the conditions of the melt extrusion process in the production of the novel monofilament yarn from the thermoplastic polyurethane (succinate content 30%, refer to Table 25) having a hardness of 90A.

TABLE 42

| | | | |
|---|---|---|---|
| Extruder (° C.) | Cylinder | C1 | 180 |
| | | C2 | 180 |
| | | C3 | 182 |

| | | |
|---|---|---|
| | Adapter | 182 |
| | Pump (G/P) | 182 |
| | Dies | 215 |
| Cooling section (° C.) | Cooling water | 20 |
| Drawing section | Roll (G/R1) | 40 |
| (rpm) | Roll (G/R2) | 200 |
| Aging section (° C.) | | 80 |

| | |
|---|---|
| Winding section (rpm) | 200 |

Table 43 presents the conditions of the melt extrusion process in the production of the novel monofilament yarn from the thermoplastic polyurethane (succinate content 60%, refer to Table 35) having a hardness of 70A.

TABLE 43

| | | | |
|---|---|---|---|
| Extruder (° C.) | Cylinder | C1 | 130 |
| | | C2 | 135 |
| | | C3 | 140 |

| | | |
|---|---|---|
| | Adapter | 145 |
| | Pump (G/P) | 145 |
| | Dies | 160 |
| Cooling section (° C.) | Cooling water | 20 |
| Drawing section | Roll (G/R1) | 40 |
| (rpm) | Roll (G/R2) | 200 |
| Aging section (° C.) | | 40 |

| | |
|---|---|
| Winding section (rpm) | 200 |

As can be seen from Tables 39 to 43, the high-hardness (Shore D type: 75D, 60D) thermoplastic polyurethane is the same in the rate of the drawing process as the low-hardness (Shore A type: 98A, 90A, 70A) thermoplastic polyurethane. More specifically, the rate is 40 rpm at the roll (G/R1) in the inlet side of the drawing section and 200 rpm (a fivefold increase) at the roll (G/R2) in the outlet side, realizing a drawing operation. In general, the high-hardness thermoplastic polyurethane (TPU) has a high crystallization rate and thus encounters no problem; but, the low-hardness thermoplastic polyurethane (TPU) has such a low crystallization rate that it is not able to maintain the defined rate (G/R1: 40 rpm, G/R2: 200 rpm) of the drawing section while the yarn is passing through the cooling and drawing sections. By using succinate and nano-silica in the low-hardness (Shore A type) thermoplastic polyurethane composition according to the present invention, it is possible to accelerate the crystallization rate and maintain the rate of the drawing section, thereby realizing a continuous spinning of yarns without yarn breakage during the cooling and drawing processes. Naturally, the use of the low-hardness thermoplastic polyurethane results in producing a thermoplastic polyurethane yarn with great stretch and recovery.

The conditions of the melt extrusion process in the production of the novel multifilament yarns are presented in Tables 44 to 49. More specifically, Table 44 presents the conditions of the melt extrusion process in the production of multifilament yarns from a thermoplastic polyurethane resin (a succinate content 0%, refer to Table 1) having a hardness of 75D; Table 45 presents the conditions of the melt extrusion process in the production of multifilament yarns from a thermoplastic polyurethane resin (succinate content 20%, refer to Table 4) having a hardness of 75D; Table 46 presents the conditions of the melt extrusion process in the production of multifilament yarns from a thermoplastic polyurethane resin (succinate content 30%, refer to Table 11) having a hardness of 60D; Table 47 presents the conditions of the melt extrusion process in the production of multifilament yarns from a thermoplastic polyurethane resin (succinate content 40%, refer to Table 19) having a hardness of 98A; Table 48 presents the conditions of the melt extrusion process in the production of multifilament yarns from a thermoplastic polyurethane resin (succinate content 50%, refer to Table 27) having a hardness of 90A; and Table 49 presents the conditions of the melt extrusion process in the production of multifilament yarns from a thermoplastic polyurethane resin (succinate content 60%, refer to Table 35) having a hardness of 70A.

TABLE 44

| | | | |
|---|---|---|---|
| Extruder (° C.) | Cylinder | C1 | 225 |
| | | C2 | 225 |
| | | C3 | 230 |
| | | C4 | 235 |

| | | |
|---|---|---|
| | Filter | 235 |
| | Pump (G/P) | 235 |
| | Dies | 235 |
| Cooling section (° C.) | Cooling air | 25 |
| Drawing section | Roll (G/R1) | 300 |
| (rpm) | Roll (G/R2) | 900 |

| | |
|---|---|
| Winding section (rpm) | 1000 |

TABLE 45

| | | | |
|---|---|---|---|
| Extruder (° C.) | Cylinder | C1 | 225 |
| | | C2 | 225 |
| | | C3 | 230 |
| | | C4 | 235 |

| | | |
|---|---|---|
| | Filter | 235 |
| | Pump (G/P) | 235 |
| | Dies | 235 |
| Cooling section (° C.) | Cooling air | 25 |
| Drawing section | Roll (G/R1) | 950 |
| (rpm) | Roll (G/R2) | 2850 |

| | |
|---|---|
| Winding section (rpm) | 3000 |

As can be seen from Tables 44 and 45, the thermoplastic polyurethane (TPU) with a hardness of 75D has a crystallization rate high somehow but not enough to make a multifilament yarn. The problem in association with the production of multifilament yarns from the 75D thermoplastic polyurethane (TPU) can be solved by using succinate, which accelerates the crystallization rate of the thermoplastic polyurethane (TPU) to increase the rates of the drawing section (G/R1: 950 rpm, G/R2: 2850 rpm) and the winding section (3000 rpm) and thereby to realize a continuous spinning of yarns without yarn breakage during the cooling and drawing processes.

TABLE 46

| | | | |
|---|---|---|---|
| Extruder (° C.) | Cylinder | C1 | 205 |
| | | C2 | 210 |
| | | C3 | 215 |
| | | C4 | 215 |

| | | |
|---|---|---|
| | Filter | 220 |
| | Pump (G/P) | 225 |
| | Dies | 225 |
| Cooling section (° C.) | Cooling air | 25 |
| Drawing section | Roll (G/R1) | 950 |
| (rpm) | Roll (G/R2) | 2850 |

| | |
|---|---|
| Winding section (rpm) | 3000 |

TABLE 47

| | | | |
|---|---|---|---|
| Extruder (° C.) | Cylinder | C1 | 195 |
| | | C2 | 195 |
| | | C3 | 200 |
| | | C4 | 200 |

| | | |
|---|---|---|
| | Filter | 215 |
| | Pump (G/P) | 220 |
| | Dies | 220 |
| Cooling section (° C.) | Cooling air | 25 |
| Drawing section | Roll (G/R1) | 950 |
| (rpm) | Roll (G/R2) | 2850 |

| | |
|---|---|
| Winding section (rpm) | 3000 |

TABLE 48

| | | | |
|---|---|---|---|
| Extruder (° C.) | Cylinder | C1 | 180 |
| | | C2 | 180 |
| | | C3 | 182 |
| | | C4 | 182 |

| | | |
|---|---|---|
| | Filter | 205 |
| | Pump (G/P) | 215 |
| | Dies | 215 |
| Cooling section (° C.) | Cooling air | 25 |
| Drawing section | Roll (G/R1) | 950 |
| (rpm) | Roll (G/R2) | 2850 |

| | |
|---|---|
| Winding section (rpm) | 3000 |

TABLE 49

| | | | |
|---|---|---|---|
| Extruder (° C.) | Cylinder | C1 | 130 |
| | | C2 | 135 |
| | | C3 | 140 |
| | | C4 | 140 |

| | | |
|---|---|---|
| | Filter | 155 |
| | Pump (G/P) | 155 |
| | Dies | 160 |
| Cooling section (° C.) | Cooling air | 25 |
| Drawing section | Roll (G/R1) | 950 |
| (rpm) | Roll (G/R2) | 2850 |

| | |
|---|---|
| Winding section (rpm) | 3000 |

As can be seen from Tables 45 and 49, the use of succinate in the production of multifilament yarns leads to acceleration of the crystallization rate to realize a continuous spinning of yarns without yarn breakage during the cooling and drawing processes, so the multifilament yarns can be produced without failure irrespective of the hardness of the thermoplastic polyurethane (Shore A or D).

As described above, the present invention involves using succinate as a polyol component and adding nano-silica to the thermoplastic polyurethane composition during polymerization in the production of yarns (i.e., monofilament or multifilament yarns) from low-hardness (Shore A type) thermoplastic polyurethane, to accelerate the crystallization rate in the melt extrusion process, realizing a continuous spinning of yarns without yarn breakage during the cooling and drawing processes.

Particularly, the thermoplastic polyurethane yarn and the fabric made from the thermoplastic polyurethane yarn according to the present invention can display great stretch and recovery by using low-hardness (Shore A type) thermoplastic polyurethane. In addition, the present invention can realize a continuous spinning of yarns without yarn breakage even when using high-hardness (Shore D type) thermoplastic polyurethane in the production of multifilament yarns.

The elongation increases, preferably by about 5 to 20%, with an increase in the succinate content of the thermoplastic polyurethane composition.

The present invention involves using nano-silica in combination with succinate in order to avoid yarn breakage during the cooling and drawing processes. Particularly, the nano-silica content of 0.5 to 5.0 phr results in realizing a continuous spinning of yarns without yarn breakage during the cooling and drawing processes.

What is claimed is:

1. A thermoplastic polyurethane yarn, which comprises a thermoplastic polyurethane composition comprising polyol, isocyanate, and glycol,
the thermoplastic polyurethane composition comprising nano-silica having a particle size of 100 nm or less,
the polyol comprising succinate.

2. The thermoplastic polyurethane yarn as claimed in claim 1, wherein the polyol further comprises adipate.

3. The thermoplastic polyurethane yarn as claimed in claim 1, wherein the thermoplastic polyurethane is a low-hardness (Shore A type) thermoplastic polyurethane.

4. The thermoplastic polyurethane yarn as claimed in claim 1, wherein the content of succinate is 5 to 30% when the thermoplastic polyurethane has a hardness of 75D.

5. The thermoplastic polyurethane yarn as claimed in claim 1, wherein the content of succinate is 5 to 40% when the thermoplastic polyurethane has a hardness of 60D.

6. The thermoplastic polyurethane yarn as claimed in claim 1, wherein the content of succinate is 5 to 45% when the thermoplastic polyurethane has a hardness of 98A.

7. The thermoplastic polyurethane yarn as claimed in claim 1, wherein the content of succinate is 10 to 55% when the thermoplastic polyurethane has a hardness of 90A.

8. The thermoplastic polyurethane yarn as claimed in claim 1, wherein the content of succinate is 20 to 75% when the thermoplastic polyurethane has a hardness of 70A.

9. The thermoplastic polyurethane yarn as claimed in claim 1, wherein a single filament of fiber is 50 denier or less when the thermoplastic polyurethane yarn is a multifilament yarn,
a single filament of fiber is 50 to 350 denier when the thermoplastic polyurethane yarn is a monofilament yarn.

10. A fabric made from the thermoplastic polyurethane yarn as claimed in claim 1.

11. The thermoplastic polyurethane yarn as claimed in claim 2, wherein the content of succinate is 5 to 30% when the thermoplastic polyurethane has a hardness of 75D.

12. The thermoplastic polyurethane yarn as claimed in claim 2, wherein the content of succinate is 5 to 40% when the thermoplastic polyurethane has a hardness of 60D.

13. The thermoplastic polyurethane yarn as claimed in claim 2, wherein the content of succinate is 5 to 45% when the thermoplastic polyurethane has a hardness of 98A.

14. The thermoplastic polyurethane yarn as claimed in claim 2, wherein the content of succinate is 10 to 55% when the thermoplastic polyurethane has a hardness of 90A.

15. The thermoplastic polyurethane yarn as claimed in claim 2, wherein the content of succinate is 20 to 75% when the thermoplastic polyurethane has a hardness of 70A.

16. The thermoplastic polyurethane yarn as claimed in claim 2, wherein a single filament of fiber is 50 denier or less when the thermoplastic polyurethane yarn is a multifilament yarn,
a single filament of fiber is 50 to 350 denier when the thermoplastic polyurethane yarn is a monofilament yarn.

17. The thermoplastic polyurethane yarn as claimed in claim 3, wherein a single filament of fiber is 50 denier or less when the thermoplastic polyurethane yarn is a multifilament yarn,
a single filament of fiber is 50 to 350 denier when the thermoplastic polyurethane yarn is a monofilament yarn.

18. A fabric made from the thermoplastic polyurethane yarn as claimed in claim 2.

19. A fabric made from the thermoplastic polyurethane yarn as claimed in 3.
